(19) United States
(12) Patent Application Publication
(10) Pub. No.: US 2002/0199047 A1
(43) Pub. Date: Dec. 26, 2002

(54) System comprising multiple co-located computer systems each having a remotely located human interface using computer I/O bus extension

(76) Inventors: Ray DuPont, Austin, TX (US); Mike Tullis, Houston, TX (US); Barry Thornton, Austin, TX (US)

Correspondence Address: Jeffrey C. Hood, Conley, Rose, & Tayon, P.C., P.O. Box 398, Austin, TX, 78767, US

(21) Appl. No.: 09/892,331

(22) Filed: Jun. 26, 2001

(51) Int. Cl. G06F 13/00

(52) U.S. Cl. 710/100

(57) ABSTRACT

A system and method operating a computer system in which one or more centrally located computers are coupled to one or more respective human interfaces (HIs) located remotely from the computers. Each computing system includes a CPU, a memory coupled to the CPU, a first I/O bus coupled to the CPU, and a first extender coupled to the first I/O bus. Each HI includes one or more HI devices, a second extender coupled to the HI devices, a second I/O bus coupled to the second extender, and HI circuitry coupled to the second I/O bus and the one or more HI devices. A transmission medium couples the first and second extenders, where the one or more HI devices are useable by a user to interface with the computing system. The second extender, second I/O bus, and HI circuitry may be included in an HI device, e.g., a monitor or keyboard.

### PRIORITY CLAIM

This application claims benefit of priority of provisional application Ser. No. ______ titled “Computer System Having a Remotely Located Human Interface Using Computer I/O Bus Extension” filed on Jun. 21, 2001, whose inventors are Ray DuPont, Mike Tullis, and Barry Thornton.

### BACKGROUND OF THE INVENTION

1. Field of the Invention

The present invention relates generally to computer systems and specifically to co-located computer systems which have remotely located human interfaces.

2. Description of the Related Art

The components of a computer system (such as PCs, minicomputers and mainframes), may be divided into two functional units—the computing system 102 and the human interface (or “HI”) 130 to the computing system. For a PC, the computing system may be the CPU, memory, hard drive, power supply and similar components. The computing system may be comprised in a chassis which holds the motherboard, power supply, hard drive and the like. The human interface 130, on the other hand, may comprise those devices that humans use to transfer information to and/or receive information from the computing system. The most commonly recognized devices which form part of the human interface with the computing system include the monitor, keyboard, mouse and printer. The human interface may comprise a variety of other devices, such as a joystick, trackball, touchpad, microphone, speakers, and telephone, as well as other devices too numerous to specifically mention.

In current computer systems, e.g., current PC architectures, the human interface 130 (e.g., the display monitor, mouse, and keyboard, etc.) is closely located to the computer system, by a distance typically less than about 10 feet. The computing system 102 generates and/or receives human interface signals, e.g., display monitor, mouse and keyboard formatted data, that are provided directly to/from the human interface 130 or desktop via individual specialized cables as illustrated in prior art FIG. 1A. For example, for most PCs installed at workstations, the computer monitor 116, keyboard 112 and mouse 114 rest on the desktop while the computer chassis which holds the computing system 102 rests on the floor underneath the desktop. Prior art FIG. 1B is a block diagram of the computer system illustrated in FIG. 1A. As indicated in FIG. 1B, the computing system 102 typically includes a processor 106, i.e., a CPU, a memory 104, and I/O interface logic, such as a video card 136 and an I/O interface card 137 which are coupled to the processor 106 through an I/O bus 124. The computing system 102 also typically includes chip set logic 108 for interfacing the processor 106 and memory 104 with the I/O bus 124. As is well known, two or more computing systems 102 may be connected together in a network configuration.

While the above-described network configuration is quite common in many business establishments, recently, a number of issues, in particular, security concerns, have been raised in connection with such network designs. Business contacts, vendor information, contracts, reports, compilations, proprietary software, access codes, protocols, correspondence, account records, business plans are just some of the fundamental assets of a company which are oftentimes accessible from an employee's computer where it can be quickly copied onto a floppy disk and stolen.

Disk and CD drives may also be used to introduce illegal, inappropriate or dangerous software to a computer. Storing bootlegged software can expose a company to copyright infringement claims. Computer games often reduce employee productivity. If imported onto a computer system, computer pornography may create a hostile work environment which leads to a sexual discrimination lawsuit against the company. Computer viruses can cause the loss of critical information stored on a computer. Finally, the computing system itself may be damaged or otherwise misconfigured when left accessible to technically oriented employees who take it upon themselves to attempt to repair and/or modify the computer system.

Another concern often raised in connection with the present practice of placing the computer system at the desktop is that such workstation designs actual work against proper maintenance of the computing system. When placed underneath the desktop, computing systems are often forced to absorb physical shocks when accidentally kicked, knocked over or struck by falling objects, any of which could result in damage to the various electronic components, located within the chassis, which comprises the computing system. Oftentimes, a computing system is placed in a “convenient” location and not in a location designed to keep it cool. A computer system typically includes a cyclonic fan designed to direct a constant flow of cooling area at the heat-generating components of the computing system. However, if a barrier is placed a few inches in front of the fan intake, the efficiency of the fan is reduced dramatically. Similarly, placing the computer system against a wall or running cables in front of the fan adversely affects the ability of the fan to properly cool the computing system. Finally, even in relatively clean office environments, the fan tends to draw in dirt and other dust particles into the interior of the computer chassis where they are deposited on the heat-generating electronic components which comprise the computing system. As dust tends to insulate the components on which it is deposited, the ability of such components to dissipate heat becomes degraded when a layer of dust collects on the component.

Logistical support, too, becomes a vexing problem for computer-intensive organizations when computing systems are scattered throughout a facility. When machine failures occur, the repair person must go to the machine to diagnose and repair the machine. Oftentimes, this entails multiple visits to the machine's location, particularly when the first examination reveals that replacement parts or a replacement machine are needed. Similarly, software upgrades and other performance checks become quite time-consuming tasks when personnel must travel to each machine where the software resides locally.

Finally, many office buildings were designed before the advent of the age of the PC. As a single PC can consume over 300 watts of power, a heavily computerized workplace could potentially demand power in excess of the amount available. Similarly, the heat generated by the large number of computers installed in modern workplaces can easily overwhelm the air conditioning capacity of a building's HVAC system, thereby causing room temperatures to rise above those levels preferred by the occupants of the building.

These concerns have been driving the development of the network computer (or “NC”) and other so-called “thin” computer solutions. While various NC designs have been proposed, most entail removal of the auxiliary memory (also known as the hard drive) and substantially reducing the size of the processor. All software applications and data files would be stored on the network and the NC would be limited to accesses of network software and data files. Most NC designs also propose that all disk drives (typically, the CD and floppy drives) be removed, thereby eliminating the ability of the NC user to import or export software applications and/or data files.

The development of the NC is, in part due to a recognition by the computer industry of security and other problems which have arisen due to the evolution of computer networks into their present configuration. However, the NC is not a fully satisfactory solution to these problems. While removing much of the processing capability from the workstation, most NC designs propose leaving sufficient intelligence at the workstation to access the Internet, load software applications retrieved from the network memory and perform other operations. Thus, while reduced in complexity, NCs will still have maintenance, power and cooling concerns. Thus, while the NC represents a step in the right direction, many of the aforementioned issues cannot be resolved by wide-scale implementation of NCs.

In order to fully resolve the aforementioned issues, in some current systems the entire computing system is physically separated from the human interface, specifically, by keeping the human interface (monitor, keyboard, mouse and printer) at the desktop or workstation while relocating the associated computing system (motherboard, power supply, memory, disk drives, etc.) to a secured computer room where plural computing systems are maintained. By securing the computing systems in one room, the employer's control over the computer systems is greatly enhanced. For example, since employees no longer have personal access, through the floppy or CD drive, to the memory subsystem, employees can not surreptitiously remove information from their computing system. Nor can the employee independently load software or other data files onto their computing system. Similarly, the employee can no longer physically change settings or otherwise modify the hardware portion of the computer. Maintenance is also greatly facilitated by placement of all of the computing systems in a common room. For example, the repair technicians and their equipment can be stationed in the same room with all of the computing systems. Thus, a technician could replace failed components or even swap out the entire unit without making repeated trips to the location of the malfunctioning machine. Such a room can be provided with special HVAC and power systems to ensure that the room is kept clean, cool and fully powered.

U.S. Pat. No. 6,012,101 titled “Computer Network Having Commonly Located Computer Systems”; U.S. Pat. No. 6,119,146 titled “Computer Network Having Multiple Remotely Located Human Interfaces Sharing a Common Computing System”; U.S. Pat. No. 6,038,616 titled “Computer System With Remotely Located Interface Where Signals are Encoded at the Computer System, Transferred Through a 4-wire Cable, and Decoded at the Interface” disclose systems where a plurality of computing systems are located at one location, and the human interfaces associated with these computing systems are remotely located at respective desktops.

FIG. 2 illustrates an exemplary prior art system where the human interface is remotely located from the computing system. The system of FIG. 2 includes a computing system, an upstream encoder, a communication medium, a downstream decoder, and the human interface devices. The downstream decoder and the human interface devices are located remotely from the upstream encoder and the computing system. This system employs a protocol wherein human interface signals generated by the computing system are encoded by the upstream encoder into a format which allows transmission over a lengthy distance to the remote location where the human interface devices are located. The encoded signals are then transmitted over the communication medium. The encoded human interface signals are received and decoded by the downstream decoder at the remote location, being converted back into the originally generated human interface signals for propagation to the human interface devices. Human interface signals generated by the human interface devices are similarly encoded by the downstream decoder, transmitted over the communication medium, decoded by the upstream encoder, and provided to the computing system. Thus, to date the separation of the computing system from the human interface has involved extension of the human interface signals, (monitor, mouse, keyboard, USB and other I/O signals), i.e., extensions of already existing I/O signals, that is, the human interface signals are generated by the computer (or human interface device), are changed or reformatted as needed for transmission to a distant or remote location, and then converted back to their original format.

Inside the computing system, the I/O or extension bus (the PCI bus in most current implementations) interfaces to I/O circuitry, wherein the I/O circuitry generates the human interface signals to the outside world as illustrated in FIG. 2. Current systems offered by ClearCube Technologies operate whereby the encoding function occurs inside the computer, but for other purposes is the same as shown in FIG. 2. In this implementation the reverse process, that is reformatting of the signals for use with the HIDs themselves, occurs in a box at the Desktop. Typically the data format used is analog and the distance are up to 200 meters.

However, these systems may have various drawbacks due to the cost of the encoder and the decoder circuitry. In other words, these systems require generation of human interface signals, encoding of these signals, and subsequent decoding of these signals for regeneration of the original human interface signals. These systems may also suffer from limited flexibility. Therefore, improved systems and methods are desired for providing a computing system having a remotely located human interface.

### SUMMARY OF THE INVENTION

Various systems and methods are presented for operating a computer system. In one embodiment, the computer system may comprise a computing system at a first location, and one or more human interface devices at a second location. The one or more human interface devices are located remotely from the computing system, e.g., more than 10 feet, or more than 20 feet, from the computing system. In other words, the second location is located remotely from the first location. In one embodiment, the computing system may include a CPU, a memory medium coupled to the CPU, a first I/O bus coupled to the CPU, and a first extender coupled to the first I/O bus. The computer system may further include a second extender, a second I/O bus coupled to the second extender, and human interface circuitry coupled to the second I/O bus, wherein each of the second extender, the second I/O bus, and the human interface circuitry are remotely located at the second location. The human interface circuitry is coupled to the one or more human interface devices.

Additionally, a transmission medium may couple the first and second extenders. In one embodiment, the transmission medium coupling the first and second extenders may be a 4-wire cable. In another embodiment, the transmission medium may be a serial bus coupled between the first extender and the second extender. Thus, the transmission signals may be serial bus signals, e.g., high speed serial bus signals generated on a high speed serial bus. Although the transmission medium is preferably a serial bus, in some embodiments, the transmission medium may be a parallel bus. In various other embodiments, the transmission medium may be a wireless medium, an IEEE 1394 or IEEE 1394.2 bus, a fiber optic medium, a switched fabric bus, such as an Infiniband bus, or any other suitable transmission medium.

In one embodiment, the first extender may include first I/O bus interface circuitry for interfacing to the first I/O bus, and the second extender may include second I/O bus interface circuitry for interfacing to the second I/O bus. In one embodiment, the first extender, the second extender, and the transmission medium may operate as a single I/O bus bridge between the first I/O bus and the second I/O bus. In one embodiment, the first extender may operate as a first portion of the I/O bus bridge, and the second extender may operate as a second portion of the I/O bus bridge. Furthermore, in one embodiment, the first extender and the second extender may collectively implement an I/O bridge register set of the single I/O bus bridge. For example, the first extender may implement a first portion (e.g., a first half) of the I/O bridge register set, and the second extender may implement a second portion (e.g., a second half) of the I/O bridge register set.

In one embodiment, each of the first extender and the second extender may include parallel/serial transceivers for converting parallel data generated on the first parallel bus and second parallel bus, respectively, to serial data for transmission on the serial bus and for converting serial data received from the serial bus to parallel data for generation on the first parallel bus and second parallel bus, respectively.

The one or more human interface devices are useable by a user to interface with the computing system, and the human interface circuitry, or device interface circuitry, operates to communicate human interface device signals with the human interface device. For example, where the one or more human interface devices comprise a display monitor, the human interface circuitry may include video display circuitry for providing video signals to the display monitor; where the one or more human interface devices comprise a keyboard, the human interface circuitry may include keyboard circuitry for communicating keyboard signals with the keyboard, and so on. It is noted that the one or more human interface devices may be coupled to the human interface circuitry, or to the second I/O bus, in a number of different ways, including standard interface cables, USB cables, wireless media, e.g., as specified by the 802.11 protocol, optical fiber, or any other suitable communication medium.

In one embodiment, user input/output may be received from/provided to a human interface device, where the human interface device may be one of a monitor, a keyboard, a mouse, audio speakers (or headphones), a microphone, a printer, a scanner, a telephone, a removable storage medium (e.g., an optical drive, a floppy drive, a tape drive, or a hard disc drive), a biometric sensor (e.g., for access control), a barcode reader, a VR interface device, and a PDA IR device, among others. In one embodiment, the user input from the human interface device may be received by the device interface circuitry.

The computer system may operate as follows. User input may be received to a human interface device, such as mouse or keyboard input. The received user input may be provided to human interface circuitry, which generate first I/O bus signals on the second I/O bus. Thus the first I/O bus signals may be generated on the second I/O bus in response to the user input, i.e., generated by the human interface circuitry corresponding to the human interface device. In one embodiment, the first I/O bus signals generated on the second I/O bus may comprise parallel bus signals generated on a parallel bus, such as a PCI bus.

Transmission signals may be generated on a transmission medium in response to the first I/O bus signals, and the transmission signals may be transmitted to the computing system. In one embodiment, the generation of the transmission signals and the transmittal of the transmission signals to the computing system may be performed by the second extender.

The computing system may receive the transmission signals from the transmission medium. Then, second I/O bus signals may be generated on the first I/O bus in the computing system in response to the received transmission signals. In one embodiment, the reception of the transmission signals from the transmission medium, and the generation of the second I/O bus signals on the second I/O bus may be performed by the first extender. In one embodiment, the second I/O bus signals generated on the first I/O bus may comprise parallel bus signals generated on a parallel bus, such as a PCI bus. The second I/O bus signals may correspond or be equivalent to the first I/O bus signals.

Finally, the computing system may perform an operation in response to the second I/O bus signals, where the operation is in response to the user input.

In the reverse direction, the computing system may generate first I/O bus signals on a first I/O bus in response to executing a software application. The first I/O bus signals comprise data for communicating with a human interface device.

Transmission signals may be generated on a transmission medium in response to the first I/O bus signals, and transmitted to a second location remote from the first location. In one embodiment, the first extender may receive the first I/O bus signals and generate the transmission signals on the transmission medium in response thereto, and transmit the transmission signals to the second location.

The transmission signals may be received at the second location, and second I/O bus signals may be generated on a second I/O bus in response to the received transmission signals. In one embodiment, the second extender may receive the transmission signals from the transmission medium, and generate the second I/O bus signals on the second I/O bus.

Human interface circuitry coupled to the second I/O bus may receive the second I/O bus signals and generate human interface signals. Thus the human interface signals may be generated in response to the second I/O bus signals and provided to at least one human interface device. Finally, the human interface device may operate in response to the human interface signals, e.g., to display data or operate a mouse or keyboard.

Thus, by implementing the above methods, the one or more human interface devices may operate as if they were located in the first location and directly connected by human interface cables to the computing system. In other words, the extended distance between the computing system and the remote human interface may be transparent to the user.

In one embodiment, the computing system may be a “computer on a card”, also referred to as a computer card or “blade”. In other words, the computing system may be comprised on a circuit card which may include standard computing system components such as a CPU, memory, and power supply, as well as an extender, e.g., a PCI extender. The extender may be operable to couple to the serial bus and may operate in conjunction with the extender device at the remote location (the location of the remote human interface) to extend the functional distance between the computing system and the human interface, as mentioned above.

In one embodiment the computing system may include a cabinet, referred to as a cage, having a plurality of slots. The computer card may be adapted to be inserted into one of the slots of the cage. The computer card may be operable to slide into a slot of the cage, thereby making contact with a cage connector which may couple to the transmission medium. The cage may be operable to receive a plurality of such computer cards via the plurality of slots, thus providing a means for co-locating a plurality of computing systems, each having a remote human interface, as described above. It is noted that although the computer card is preferably comprised in a rectangular slide drawer frame, the computer card may have various other form factors as desired, including square, cubic, spherical, hexagonal, hexagonal prism, circular, or any other form factor, as desired.

In one embodiment, a computer card may be inserted into a cage slot, and may thereby be coupled, for example, to a keyboard, mouse, and monitor, (or other devices), which comprise the human interface for that computer card. Additional computer cards may be similarly inserted into respective slots and coupled to respective human interfaces. Thus, the computer cards may all be installed in the cage at a central location, while the user interface for each computer card may be located remotely from the cage, such as at the respective work areas of the users of the computer cards. The plurality of computer cards installed in the cage may be connected through a backplane or cabling to form a computer network.

In one embodiment, the one or more human interface devices which compose each human interface may be coupled to a transmission medium through an extender device, such as a PCI extender device. For example, the human interface associated with a computer card may be coupled to the transmission medium through the extender device. In other words, the monitor, the keyboard, and the mouse (and any other human interface device comprised in the human interface for the computer card) may plug in to the extender device. Similarly, the human interface devices corresponding to additional computer cards may be coupled to their respective transmission mediums through respective extender devices.

Thus, in one embodiment, each computer card may include a first I/O bus and an extender, and each corresponding human interface may include an extender device which includes an extender and a second I/O bus, and which may be coupled to one or more human interface devices, where the first extender and the second extender may be coupled via the transmission medium, e.g., the serial bus.

In one embodiment, the components of each extender device (the extender and the I/O bus) may be comprised in a human interface device, such as the display or monitor of each respective human interface. Thus, in one embodiment the monitor of each human interface may provide ports for coupling the other human interface devices to the serial bus. As mentioned above, the inclusion of the extender device in the monitor is meant to be an illustrative embodiment and is not intended to limit the invention thus. In other words, any of the human interface devices may be adapted to include the extender and the second I/O bus, through which the other human interface devices may couple to the serial bus.

In one embodiment, the I/O bus, the I/O bus extender, and the human interface circuitry may form a human interface extender device. For example, the I/O bus may be a PCI bus and the I/O bus extender may be a PCI bus extender, in which case the human interface extender device may couple to one or more PCI human interface devices, where the human interface extender device and the one or more human interface devices are located at a user location. The human interface extender device may couple to its corresponding remote computing system through a transmission medium, such as a high speed serial bus, thereby providing a means for a user to interface with a remote computing system. In one embodiment, the human interface extender device may be included in a chassis, thereby providing a convenient encapsulation of the human interface extension functionality.

### BRIEF DESCRIPTION OF THE DRAWINGS

A better understanding of the present invention can be obtained when the following detailed description of the preferred embodiment is considered in conjunction with the following drawings, in which:

FIG. 1A illustrates a prior art computer system having a computing system and human interface devices directly coupled to the computing system through standard human interface cables;

FIG. 1B is a block diagram of the prior art computer system of FIG. 1;

FIG. 2 is a block diagram of a prior art computer system having a computing system and one or more human interface devices remotely located from the computing system, where the computing system generates human interface signals that are encoded for transmission to the remote location and then converted back to human interface signals for provision to the one or more human interface devices;

FIG. 3A illustrates a computer system using first and second PCI extenders to communicate between a computing system and a remote human interface, according to one embodiment;

FIG. 3B illustrates a computer system using first and second PCI extenders to communicate between a computing system on a card and a remote human interface, according to one embodiment;

FIG. 3C illustrates a computer system where a PCI extender device is included in a display device to communicate between a computing system on a card and a remote human interface, according to one embodiment;

FIG. 4A is a block diagram of the computer systems of FIGS. 3A and 3B, according to one embodiment;

FIG. 4B is a block diagram of the computer system of FIG. 3C, according to one embodiment;

FIG. 5 illustrates a computer on a card and a cage for co-locating a plurality of such computers, according to one embodiment;

FIG. 6A illustrates a plurality of co-located computing systems coupled to corresponding remote human interfaces through PCI extender devices, according to one embodiment;

FIG. 6B illustrates the system of FIG. 6A, where each PCI extender device is included in a corresponding monitor, according to one embodiment;

FIGS. 7A-7G are block diagrams of various embodiments of a remote human interface with a PCI extender device;

FIG. 8 is a block diagram of a PCI extender, according to one embodiment;

FIG. 9 flowcharts a method for sending user input from a remote human interface device to a computing system, according to one embodiment; and

FIG. 10 flowcharts a method for sending user interface signals from a computing system to a remote human interface device, according to one embodiment.

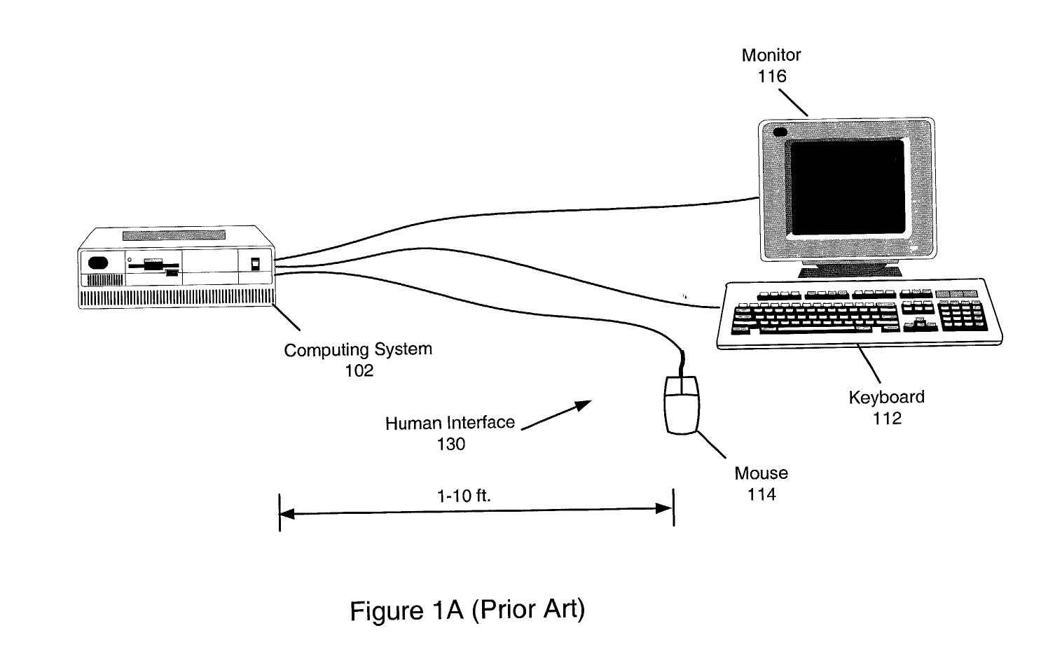

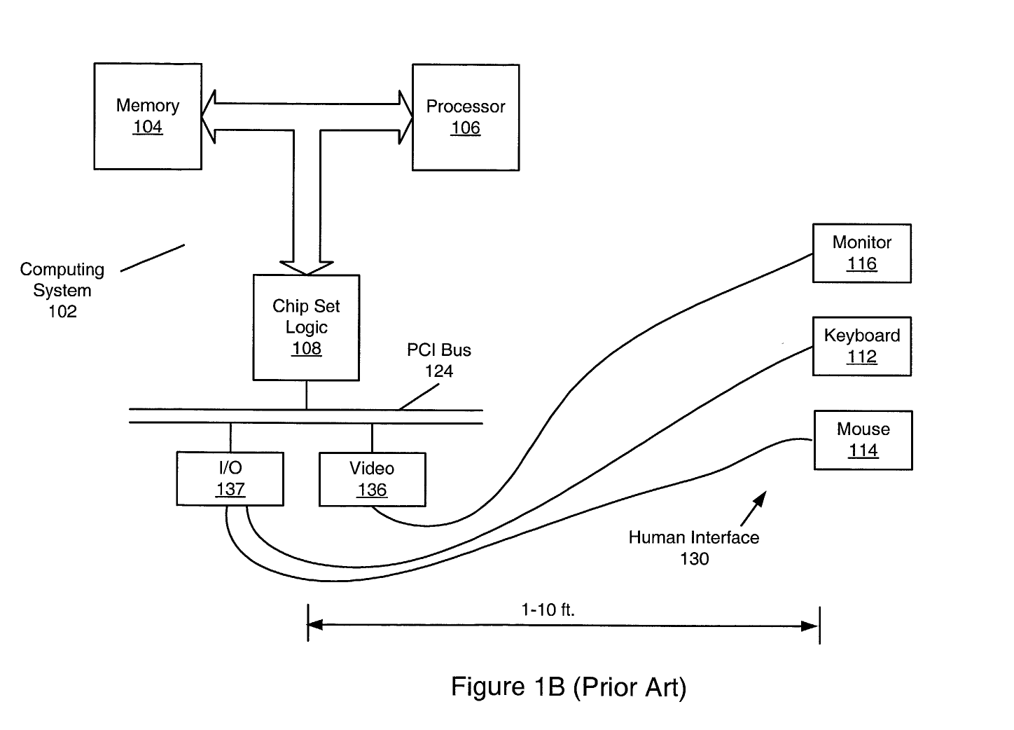

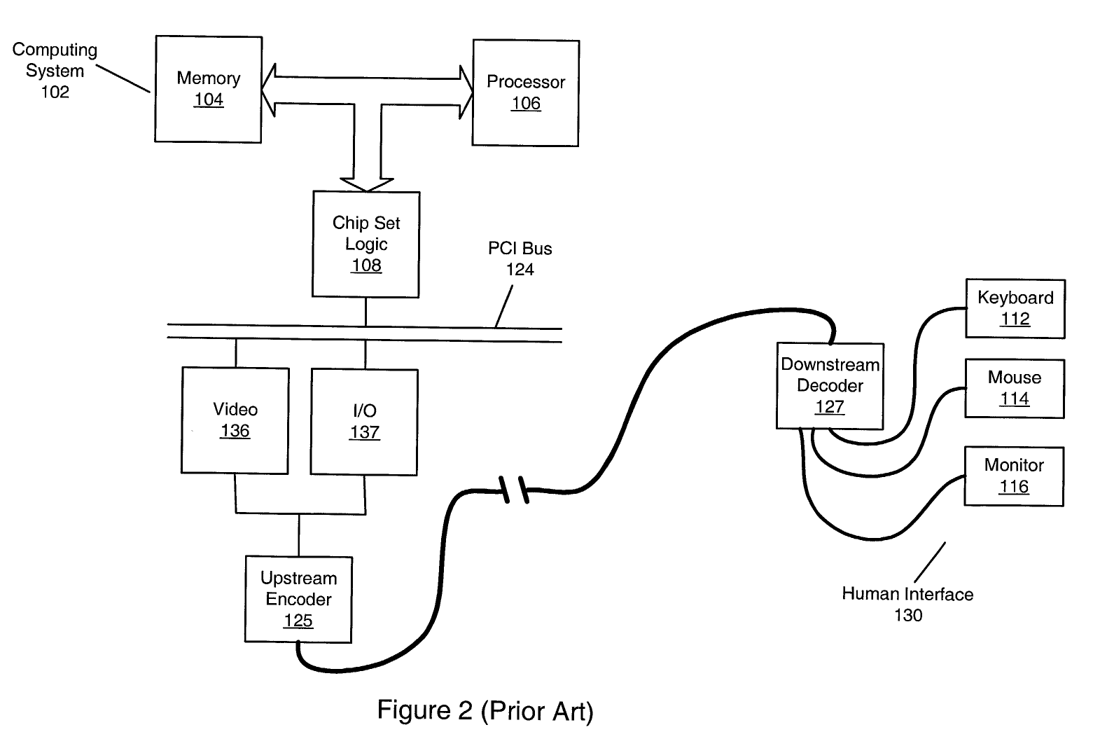

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Incorporation by Reference

The following patents and patent applications are hereby incorporated by reference as though fully and completely set forth herein:

U.S. Pat. No. 6,012,101 titled “Computer Network Having Commonly Located Computer Systems” issued on Jan. 4, 2000, whose inventors are Andrew Heller, Barry Thornton, Daniel Barrett, and Charles Ely;

U.S. Pat. No. 6,119,146 titled “Computer Network Having Multiple Remotely Located Human Interfaces Sharing a Common Computing System” issued on Sep. 12, 2000, whose inventors are Andrew Heller, Barry Thornton, Daniel Barrett, and Charles Ely;

U.S. Pat. No. 6,038,616 titled “Computer System With Remotely Located Interface Where Signals are Encoded at the Computer System, Transferred Through a 4-wire Cable, and Decoded at the Interface” issued on Mar. 14, 2000, whose inventors are Andrew Heller, Barry Thornton, Daniel Barrett, and Charles Ely;

U.S. Pat. No. 6,070,214 titled “Serially Linked Bus Bridge For Expanding Access Over A First Bus To A Second Bus” issued on May 30, 2000, whose inventor is Frank Ahern;

U.S. Pat. No. 5,764,924 titled “Method And Apparatus For Extending A Local PCI Bus To A Remote I/O Backplane” issued on Jun. 9, 1998, whose inventor is Soon Chul Hong;

U.S. Pat. No. 6,003,105 titled “Long-Haul PCI-to-PCI Bridge” issued on Dec. 14, 1999, whose inventors are Dominique Vicard, Jean-Paul Moiroux, and Pierre-Yves Thoulon;

U.S. patent application Ser. No. 09/728,667 titled “Computer On A Card With A Remote Human Interface” filed on Dec. 1, 2000, whose inventors are Andrew Heller and Barry Thornton; and

U.S. patent application Ser. No. 09/728,669 titled “A System Of Co-Located Computers In a Framework Including Removable Function Modules for Adding Modular Functionality” filed on Dec. 1, 2000, whose inventor is Barry Thornton.

U.S. patent application Ser. No. 09/619,989 titled “System and Method for Providing a Remote Universal Serial Bus” filed on July 20, 2000, whose inventor is Barry Thornton.

U.S. patent application Ser. No. 09/680,760 titled “System and Method for Combining Computer Video and Remote Universal Serial Bus In An Extended Cable” filed on Oct. 6, 2000, whose inventor is Barry Thornton.

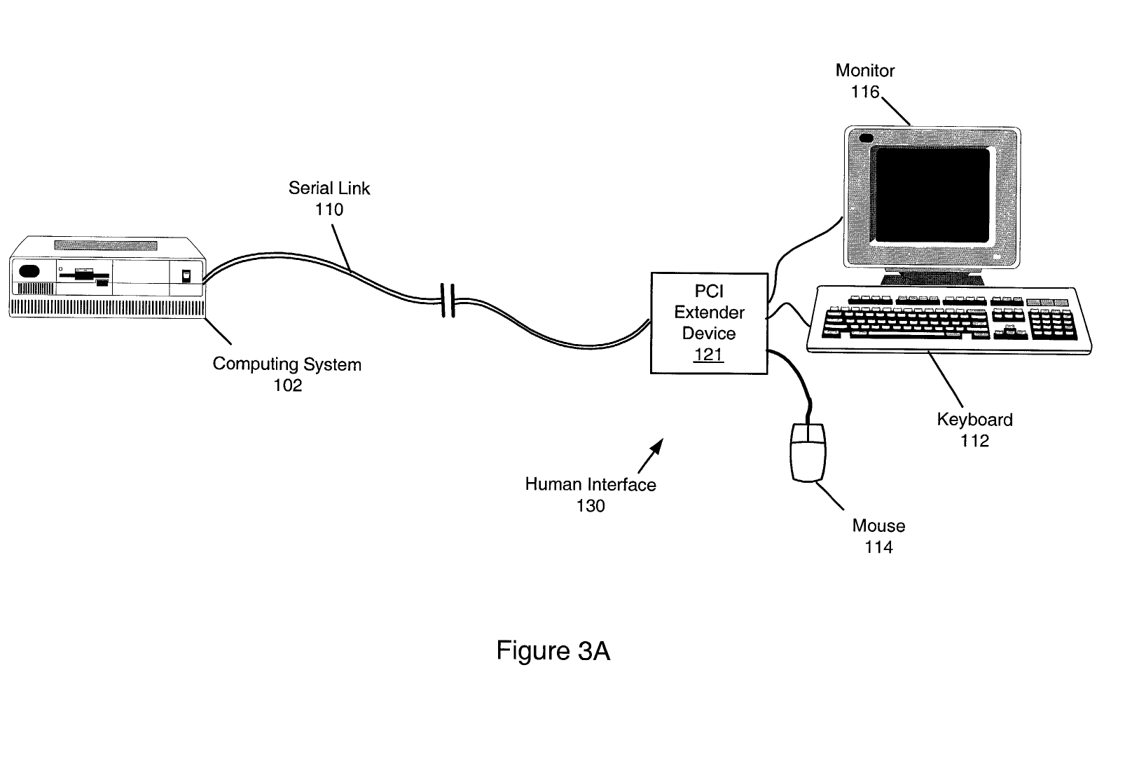

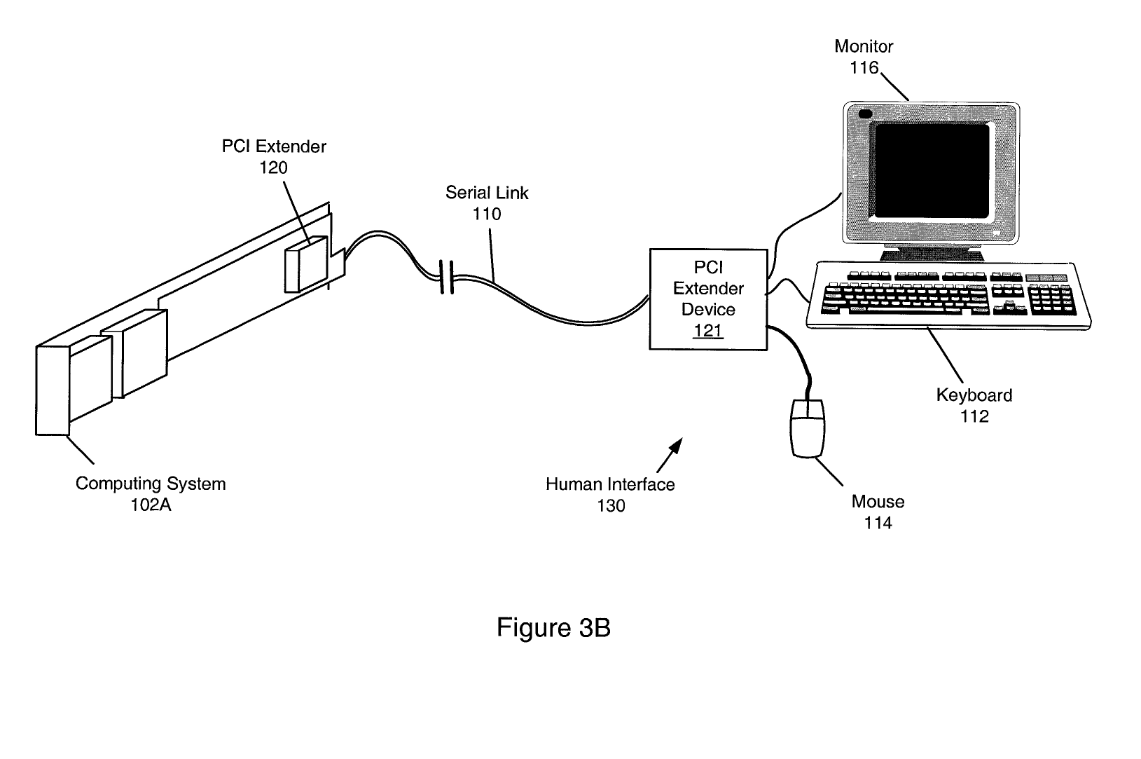

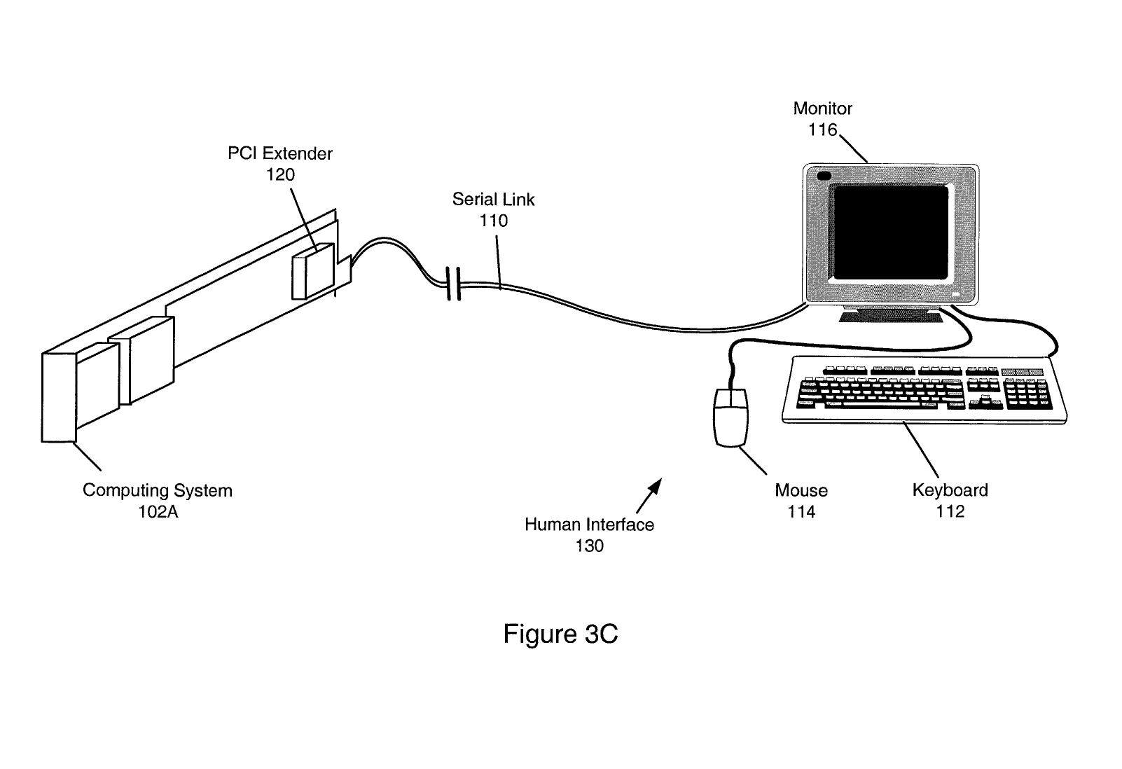

FIGS. 3A-3C—Computer System with Remote Human Interface

FIGS. 3A-3C illustrate various embodiments of a computer system where a computing system at one location is coupled through a transmission medium to a human interface at a second location, and where the second location is remotely located with respect to the first location. These embodiments are exemplary, and various other embodiments of the invention may be employed.

As used herein, the terms “first” and “second” are each used to refer to a location of a device at either the computing system location or at the human interface location. Thus a “first” device may be either at the computing system side or the human interface side, and similarly a “second” device may be either at the computing system side or the human interface side.

FIG. 3A—A Computer System with Remote Human Interface

FIG. 3A illustrates a computer system with a remote human interface, according to one embodiment. As FIG. 3A shows, the computer system may include a computing system 102 located at a first location, which is coupled to one or more human interface devices (collectively referred to as a human interface 130) located at a second location. The second location is remotely located relative to the first location. As FIG. 3A indicates, in this embodiment, the computing system 102 may be a standard personal computer (PC) which may include standard components including a chassis containing a CPU, memory, and power supply, among others.

In one embodiment, the human interface 130, i.e., the one or more human interface devices, may be located more than 10 feet (or 20 feet) from the computing system 102. Thus, in various embodiments, the human interface may be located at a distance from the computing system 102 which is greater than typically allowed in prior art “non-extended” computer systems.

Thus, as used herein, the term “remotely located” is intended to refer to separation distances greater than those possible using current conventionally designed cables such as those provided when purchasing a PC. Accordingly, the term “remotely located”, as used herein, generally refers to separation distances between 10 and 1,000 feet. However, as it is possible to utilize the disclosed techniques to separate the computing system 12 and the human interface 14 by distances greater than 1,000 feet, it should be clearly understood that the aforementioned upper limit of 1,000 feet is given by way of example and should not be construed as a limitation on the scope of the present invention. The term “remotely located” may also refer to a range greater than 15 feet, greater than 20 feet, etc.

The one or more human interface devices may include any of a monitor 116 a keyboard 112, a mouse 114, or any other human interface device. Other examples of human interface devices contemplated may include audio speakers (or headphones), a microphone, a printer, a scanner, a telephone, a removable storage medium, a biometric sensor, a barcode reader, a VR (Virtual Reality) interface device, and a PDA (Personal Digital Assistant) IR (Infra-Red) device, among others. As also indicated in FIG. 3A, the computing system 102 may be coupled to the one or more human interface devices by a transmission medium 110. In a preferred embodiment the transmission medium may be a serial link or bus 110. Various embodiments of the serial bus may include a 4-wire transmission cable, optical fiber, a wireless serial transmission medium, a switched fabric bus, e.g., an Infiniband bus, an IEEE 1394 or IEEE 1394.2 bus, or any other serial transmission medium. In another embodiment, the transmission medium 110 may be a parallel bus.

In one embodiment, the one or more human interface devices may be coupled to the transmission medium 110 through an extender device 121, also located remotely from the computing system 102, which may be operable to extend the functional distance between the computing system 102 and the human interface. In one embodiment, the extender device 121 may include an extender 120, described in more detail below. In a preferred embodiment, the extender device may be a PCI extender device, also described in more detail below. It is noted that, the computing system 102 may also include an extender 120A, (not shown in this figure), which may couple to the serial bus 110, and which, in conjunction with the remotely located extender device 121B, may be operable to extend the afore-mentioned functional distance.

FIG. 3B—A Computing System on a Card with Remote Human Interface

FIG. 3B illustrates one embodiment of a computing system 102A coupled to remote human interface 130 through the transmission medium 110, e.g., serial bus or link 110. As in the system described with reference to FIG. 3A, the one or more human interface devices may be coupled to the transmission medium 110 via extender device 121, e.g., a PCI extender device which may be operable to extend the functional distance between the computing system 102A and the human interface 130, i.e., the one or more human interface devices. Further details of the extender device 121 are provided below.

As FIG. 3B shows, in one embodiment, the computing system 102A may be a “computer on a card” or “blade”, i.e., the computing system 102A may be comprised on a circuit card which may include standard computing system components such as a CPU, memory, and power supply. In one embodiment, the computing system 102A may further include an extender 120, e.g., a PCI extender 120, which may couple to the serial bus 110 and which may operate in conjunction with the extender device 121 at the remote location (the location of the remote human interface 130) to extend the functional distance between the computing system 102A and the human interface 130, as mentioned above.

FIG. 3C—Another Computing System on a Card with Remote Human Interface

FIG. 3C illustrates the computing system 102A of FIG. 3B with an embodiment of the remote human interface in which the extender device 121 is included in the display device or monitor 116. In this embodiment, the other human interface devices included in the human interface 130, e.g., the keyboard 112 and mouse 114, may be coupled to the serial bus 110 through the monitor 116, i.e., the extender device 121 inside the monitor 116. Thus, the monitor 116 may function as a human interface ‘hub’ for other human interface devices. It should be noted that although in this embodiment the monitor 116 includes the extender device 121, it is contemplated that the extender device 121 may be included in any of the human interface devices. For example, in one embodiment, the extender device 121 may be included in the keyboard 112. In this case, the other human interface devices, e.g., the monitor 116 and mouse 114 (and/or any other human interface devices), may plug into the keyboard (i.e., the extender device 121 located in the keyboard). Other human interface devices which may be adapted to include the extender device 121 include a pointing device (e.g., a mouse, trackball, joystick, etc.), a printer, a telephone, a biometric sensor, a barcode reader, a VR interface device, and a PDA IR device, among others. Thus, in various embodiments of the invention, any of the human interface devices may be adapted to include the extender device 121, and thus function as a human interface hub for other human interface devices.

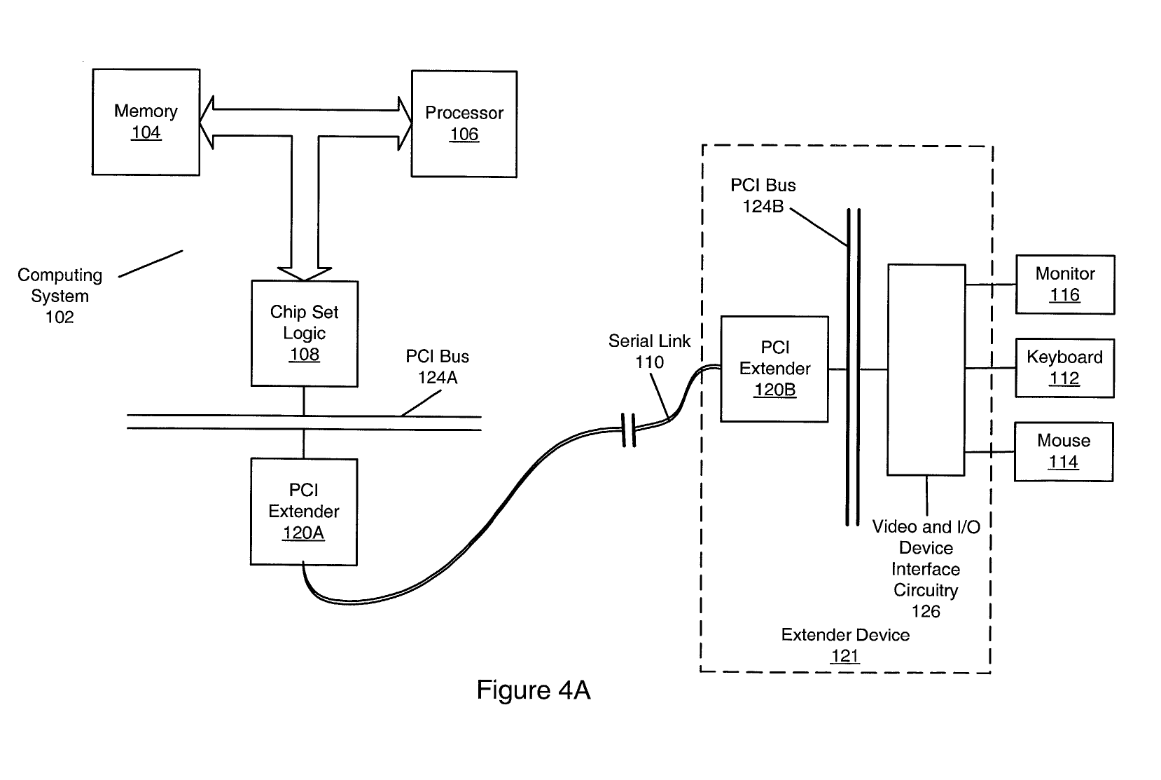

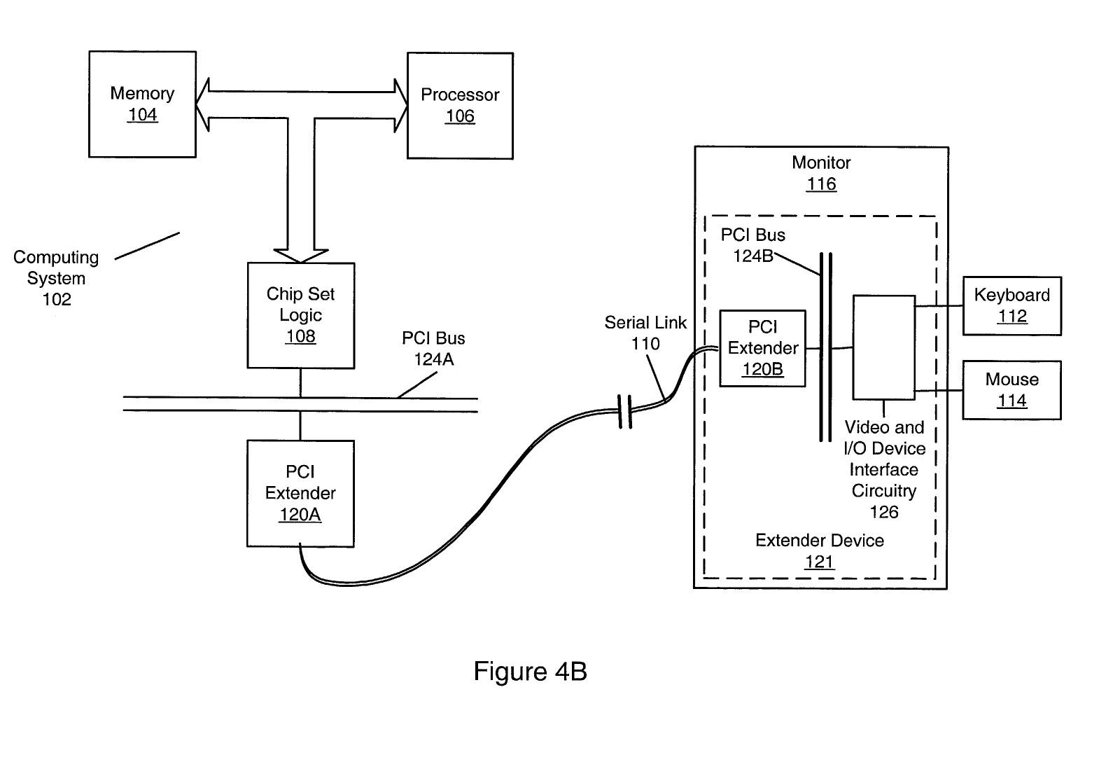

FIGS. 4A-4B—Block Diagrams of a Computer System with Remote Human Interface

FIGS. 4A and 4B are block diagrams of two embodiments of the present invention where a computing system at one location is coupled through a transmission medium to a human interface at a second location, and where the second location is remotely located with respect to the first location.

FIG. 4A—Block Diagram of a Computing System with Remote Human Interface

FIG. 4A is a block diagram of the computer systems described above with reference to FIGS. 3A and 3B, according to one embodiment. As FIG. 4A shows, the computing system 102, at a first location, may be coupled through a transmission medium, such as serial bus 110, to one or more human interface devices of a remote human interface 130, such as keyboard 112, mouse 114, and monitor 116, located at a second location.

In one embodiment, the computing system 102 may include a CPU or processor 106, a memory medium 104 coupled to the CPU 106, and a first I/O bus 124A coupled to the CPU 106, for example, through chip set logic 108. The computing system 102 may also include a first extender 120A coupled to the first I/O bus 124A, as indicated. In one embodiment, the first I/O bus 124A may be a PCI bus, and the first extender 120A may be a PCI extender 120A. In an embodiment in which the computing system 102 is a computer card 102A (i.e., a circuit card), as described above with reference to FIGS. 3B and 3C, the first extender and the first I/O bus may be comprised on the circuit card.

As FIG. 4A also shows, in one embodiment, the computer system may also include a second extender 120B coupled to the one or more human interface devices, where the second extender 120B may be remotely located relative to the first location, i.e., remotely located relative to the computing system 102. In one embodiment, a second I/O bus 124B may be coupled to the second extender 124B. As shown, human interface circuitry 126, e.g., video and I/O interface circuitry, may couple to the second I/O bus 124B and may also couple to the one or more human interface devices, i.e., keyboard 112, monitor 116, and mouse 114. The human interface circuitry 126, also referred to as device interface circuitry, may be operable to convert between human interface signals corresponding to the one or more human interface devices and bus signals corresponding to the second I/O bus 124B. It should be noted that in one embodiment, the second extender 120B, the second I/O bus 124B, and the human interface circuitry 126 may be comprised in the extender device 121, as shown. It is noted that the one or more human interface devices may be coupled to the human interface circuitry, or to the second I/O bus, in a number of different ways, including standard interface cables, USB, wireless media, e.g., as specified by the 802.11 protocol, optical fiber, or any other suitable communication medium.

Thus, in one embodiment, the transmission medium 110 may couple the first and second extenders 120, which are comprised respectively in the computing system 102 and the remote human interface 130, where the one or more human interface devices are useable by a user to interface remotely with the computing system.

It should be noted that in the preferred embodiment, the one or more human interface devices operate as if they were located in the first location and directly connected by human interface cables to the computing system. In other words, the extension of the human interface may be transparent to the user.

FIG. 4B—Block Diagram of a Computer System with Remote Human Interface

FIG. 4B is a block diagram of the computer system described above with reference to FIG. 3C, according to one embodiment. As FIG. 4B shows, the computing system 102, at a first location, may be coupled through a transmission medium, such as serial bus 110, to one or more human interface devices of the remote human interface 130, such as keyboard 112, mouse 114, and monitor 116, located at a second location remote from the first location.

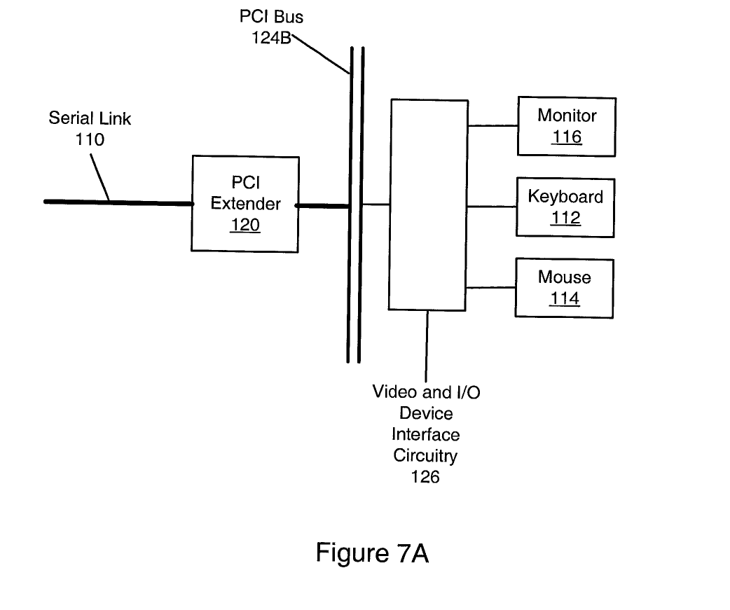

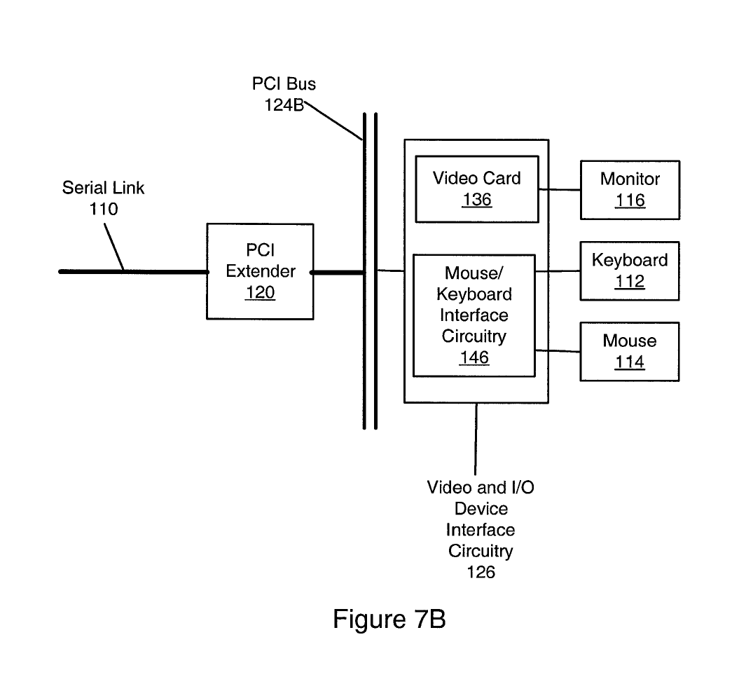

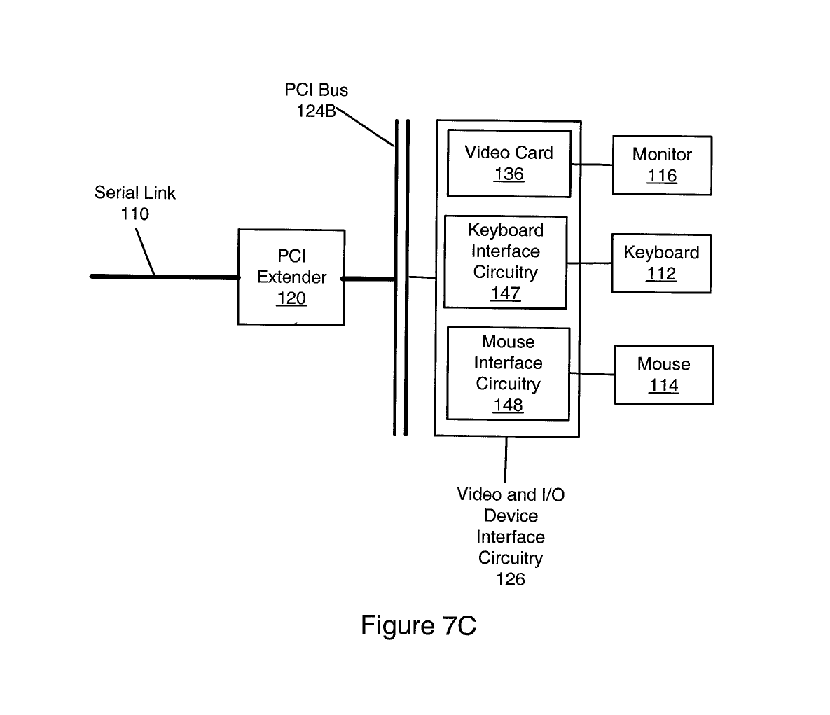

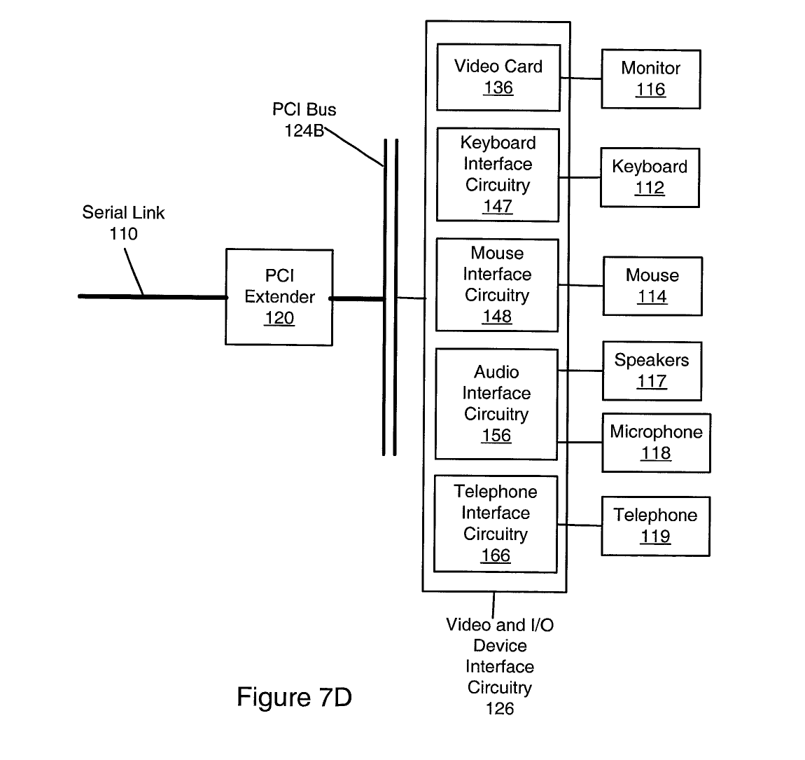

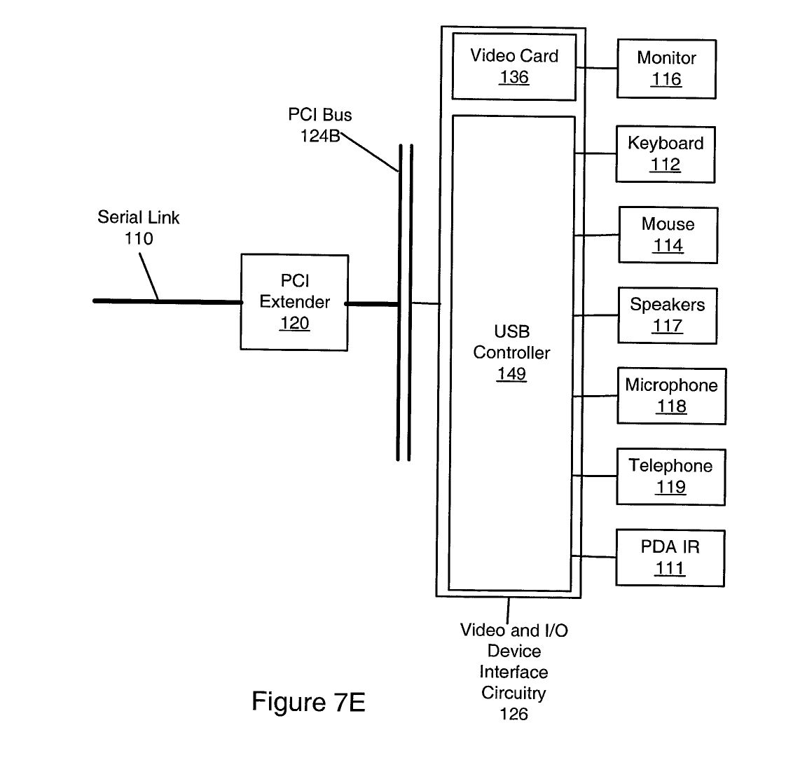

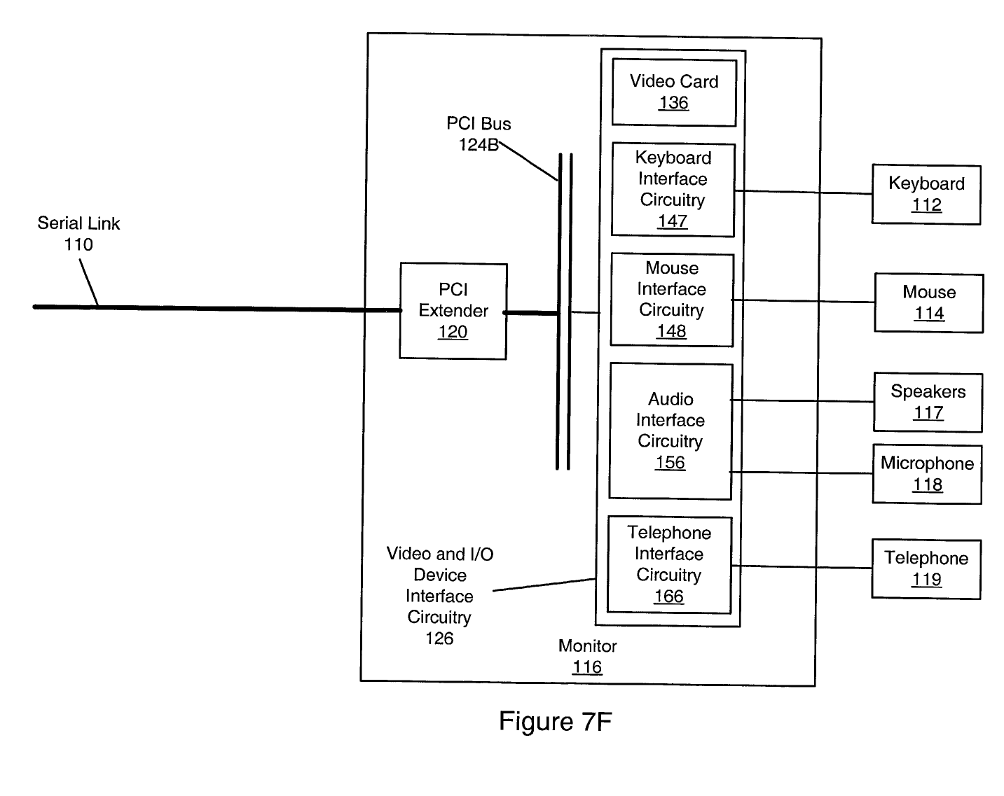

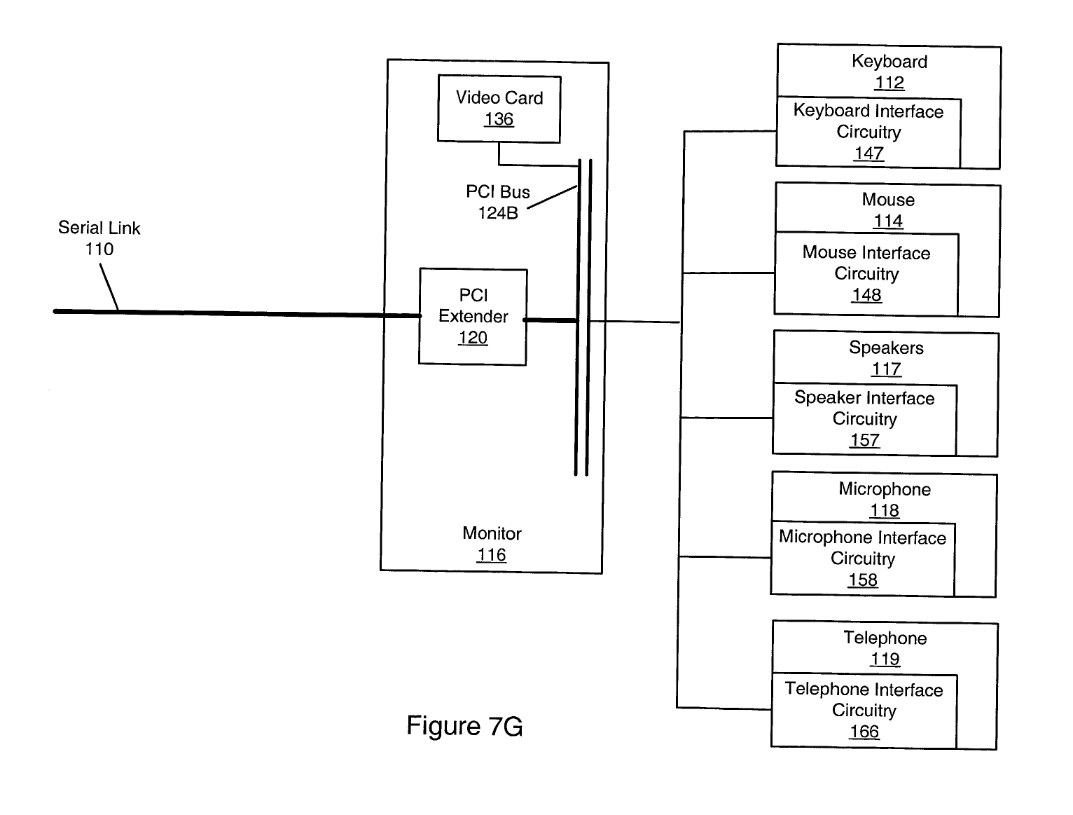

As FIG. 4B shows, in one embodiment, the extender device 121 may be comprised in the display device or monitor 116. The other human interface devices may then be coupled to the serial bus 110 through the monitor 116, i.e., through the extender device 121 comprised in the monitor. As mentioned above, it is also contemplated that the extender device 121 may be included in any of the human interface devices, which may then function as a human interface hub for other human interface devices. Note that in this embodiment, the monitor 116 includes the extender device 121, which itself comprises extender 120, I/O bus 124B, and video and I/O device interface circuitry 126, as shown. As mentioned above, the one or more human interface devices may be coupled to the monitor in a number of different ways, including standard interface cables, wireless media, e.g., as specified by the 802.11 protocol, optical fiber, or any other suitable communication medium. Other embodiments of the human interface are described below with reference to FIGS. 7A-7G.

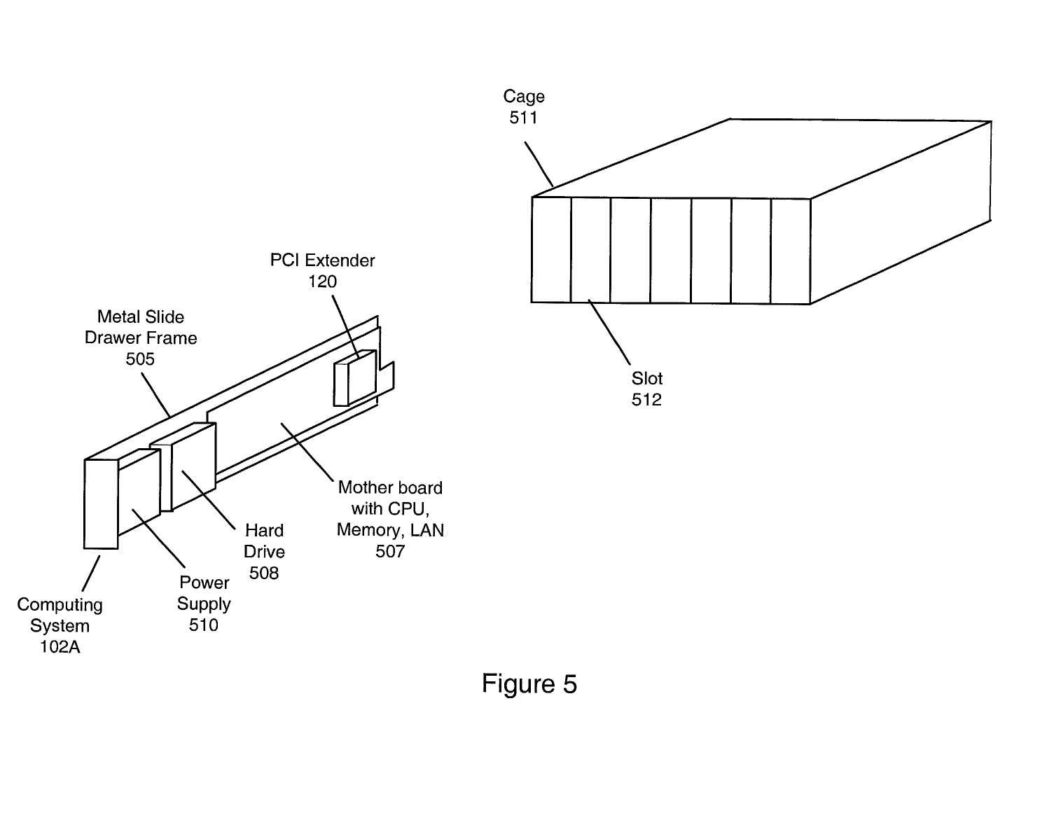

FIG. 5—A Computing System on a Card

FIG. 5 illustrates the computing system of FIGS. 3B and 3C, according to one embodiment. As FIG. 5 shows, the computing system 102A may include a motherboard 507 with CPU, memory, and networking logic, as well as a power supply 510, and possibly a hard drive 508. Thus, the computing system 102A may comprise a “computer on a card”, also referred to as a “computer card” or “blade”. As mentioned above, the computing system 102A may further include an extender 120 which may operate to extend the operational distance for a human interface located remotely from the computing system 102A.

In one embodiment the computing system 102A may include a cabinet, referred to as a cage 511, having a plurality of slots 512. The computer card may be adapted to be inserted into one of the slots of the cage. The computer card 102A may be operable to slide into a slot 512 of the cage 511, thereby making contact with a cage connector which may couple to the transmission medium 110. Thus, the computer card may comprise a complete PC on a single slide drawer frame which may be only 3 rack units high (5.25 inches), and thus may occupy a much smaller space than standard PC units. The cage 511 may be operable to receive a plurality of such computer cards via the plurality of slots 512, thus providing a means for co-locating a plurality of computing systems, each having a remote human interface, as described above. The cage may include a backplane or communication medium connecting each of the cage connectors, thereby enabling networking of the comuter cards, such as an Ethernet network. Further details of the computer card may be found in U.S. patent application Ser. No. 09/728,667 titled “Computer on a Card with a Remote Human Interface”, and U.S. patent application Ser. No. 09/728,669 titled “A System of Co-Located Computers in a Framework Including Removable Function Modules for Adding Modular Functionality” which are both incorporated by reference above.

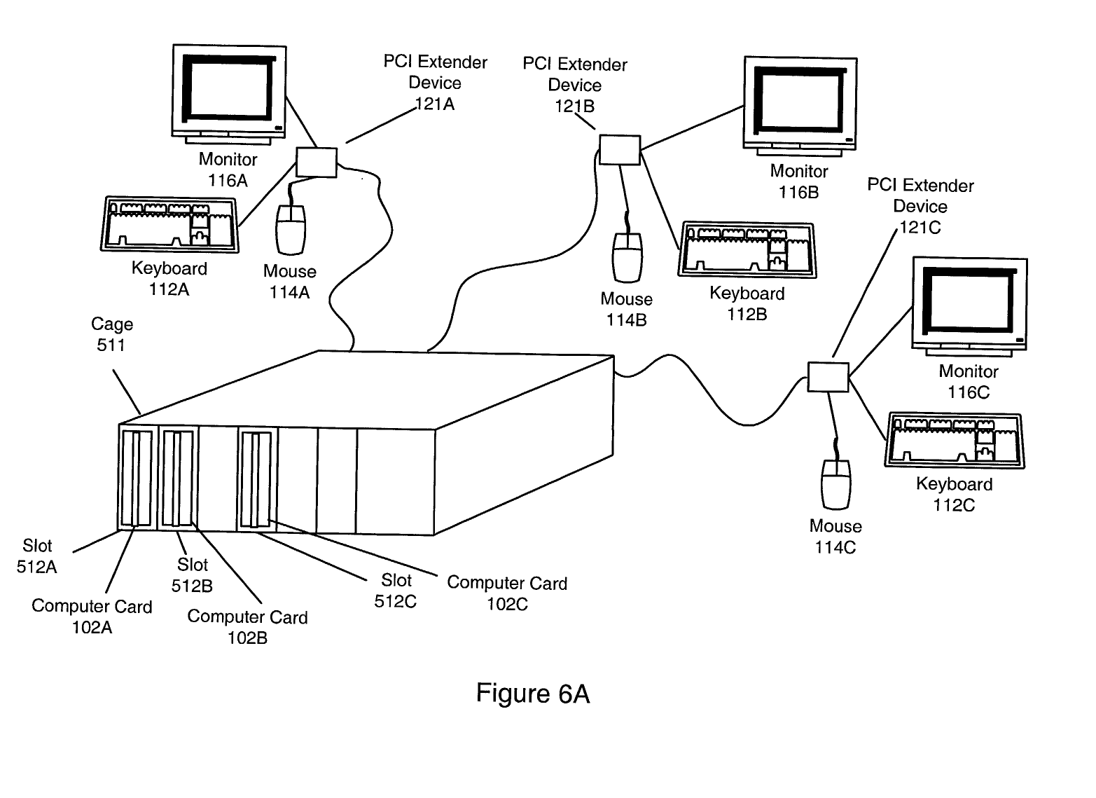

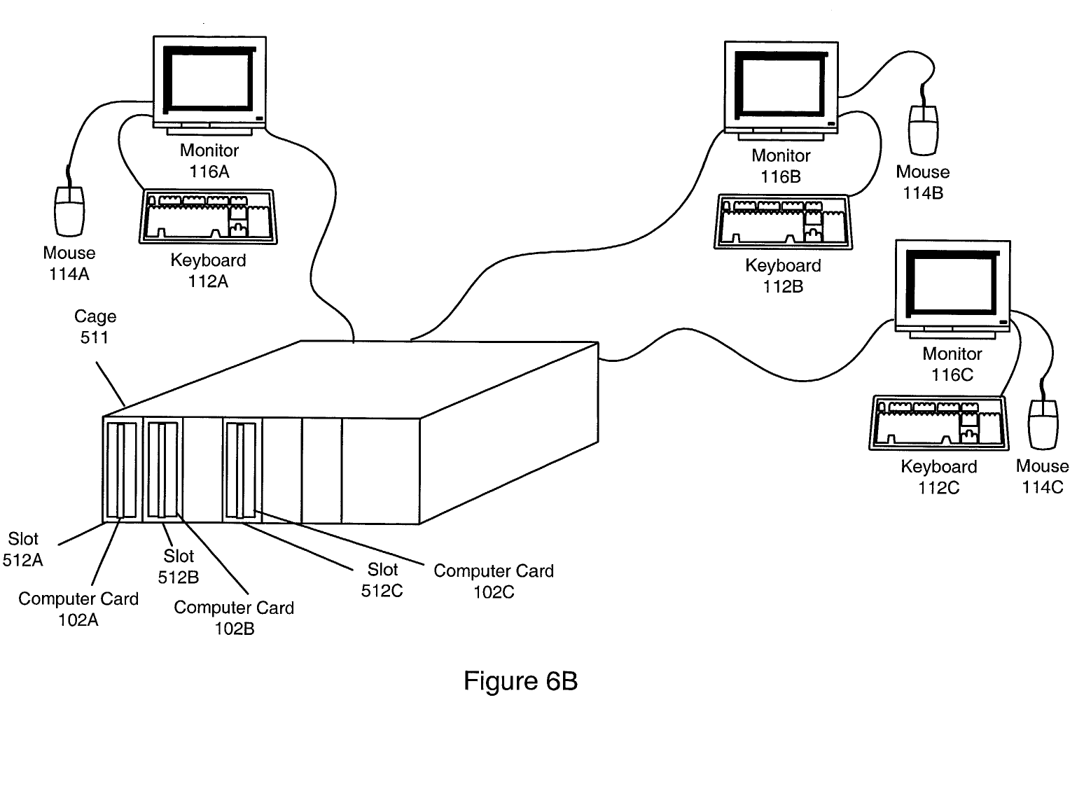

FIGS. 6A-6B—Co-located Computing Systems with Remote Human Interfaces

FIGS. 6A and 6B illustrate embodiments of the invention where a plurality of computer cards 102A-102C may be installed in respective slots of cage 511, and where each computer card may be coupled via a transmission medium to a respective human interface, i.e., one or more human interface devices.

As shown in FIG. 6A, computer card 102A may be inserted into cage slot 512A, and may thereby be coupled to keyboard 112A, mouse 114A, and monitor 116A, which comprise the human interface for that computer card. Computer cards 102B and 102C may be similarly inserted into respective slots 512B and 512C and coupled to respective human interfaces as shown. Thus, the computer cards 102A-102C may all be installed in the cage 511 at a central location, while the user interface for each computer card may be located remotely from the cage 511, such as at the respective work areas of the users of the computer cards. It should be noted that the human interface devices shown here are for illustration purposes only, and that the actual type and number of devices comprised in each human interface may vary.

As FIG. 6A also shows, in one embodiment, the one or more human interface devices which compose each human interface 130 may be coupled to a transmission medium through an extender device 121, such as a PCI extender device. For example, the human interface associated with computer card 102A may be coupled to the transmission medium through the extender device 121A, as shown. In other words, the monitor 116A, the keyboard 112A, and the mouse 114A (and any other human interface device comprised in the human interface for computer card 102A) may plug in to the extender device 121A. Similarly, as FIG. 6A shows, the human interface devices corresponding to computer cards 102B and 102C may be coupled to their respective transmission mediums through respective extender devices 121B and 121C.

Thus, in one embodiment, each computer card may include a first I/O bus 124A and an extender 120A, and each corresponding human interface 130 may include an extender device 121 which includes an extender 120B and a second I/O bus 124B, and which may be coupled to one or more human interface devices, where the first extender 120A and the second extender 120B may be coupled via the transmission medium 110, e.g., the serial bus.

FIG. 6B illustrates a computer system similar to that described with reference to FIG. 6A, but where the components of each extender device 121 (the extender 120 and the I/O bus 124) are comprised in the monitor 116 of each respective human interface 130. Thus, as FIG. 6B shows, in one embodiment the monitor 116 of each human interface may provide ports for coupling the other human interface devices to the serial bus 110, as described above with reference to FIGS. 3C and 4B. As mentioned above, the inclusion of the extender device 121 in the monitor 116 is meant to be an illustrative embodiment and is not intended to limit the invention thus. In other words, any of the human interface devices may be adapted to include the extender 120 and the second I/O bus 124B, through which the other human interface devices may couple to the serial bus 110.

FIGS. 7A-7G—Remote Human Interfaces with Extenders

FIGS. 7A-7G are block diagrams of various embodiments of remote human interfaces where one or more human interface devices are coupled to a serial bus 110 through an extender 120. These embodiments are meant to be illustrative and are not intended to limit the particular embodiments of the invention. In each of the embodiments described below, an extender 120 may be coupled to a transmission medium, such as serial bus 110. The extender 120 may also be coupled to an I/O bus, such as a PCI bus 124B. One or more human interface devices may be coupled to the PCI bus 124B through device interface circuitry, such as video and I/O device interface circuitry 126.

FIG. 7A is a block diagram of an embodiment in which the video and I/O device interface circuitry 126 for the monitor 116, the keyboard 112, and the mouse 114 may be comprised together, providing an interface whereby the monitor 116, the keyboard 112, and the mouse 114 may couple to the I/O bus, e.g., the PCI bus 124B. In one embodiment, the PCI extender 120 and the PCI bus 124B may be packaged together as extender device 121. In another embodiment, the extender device 121 may include the video and I/O device interface circuitry 126, as well.

FIG. 7B is a block diagram of an embodiment in which the video and I/O device interface circuitry 126 for the monitor 116, i.e., video card 136, is distinct from the interface circuitry for the keyboard 112 and the mouse 114, here referred to as mouse/keyboard interface circuitry 146.

FIG. 7C is a block diagram of an embodiment in which the video and I/O device interface circuitry 126 for the monitor 116, the keyboard 112, and the mouse 114 may be comprised of distinct circuits for each device. For example, the monitor 116 may couple to video card 136, the keyboard 112 may couple to keyboard interface circuitry 147, and the mouse 114 may couple to mouse interface circuitry 148, as shown. Each interface circuit may thus provide an interface for its respective human interface device to couple to the PCI bus 124B.

FIG. 7D is a block diagram of an embodiment in which the human interface devices include monitor 116, keyboard 112, and mouse 114, as well as speakers 117, microphone 118, and telephone 119. In this embodiment, each human interface device may couple to respective interface circuitry for coupling to the PCI bus 124B, with the exception of the speakers 117 and the microphone 118 which may share audio interface circuitry 156. It should be noted that in other embodiments, other human interface devices not shown, such as biometric sensors, removable storage devices, barcode scanners, and PDA IR devices, among others, may also couple to the PCI bus 124B via respective device interface circuitry.

FIG. 7E is a block diagram of an embodiment in which the interface device circuitry includes a USB host controller which may be operable to communicate with USB human interface devices, such as a USB enabled mouse, keyboard, audio devices, biometric sensors, a barcode reader, a VR interface device, or PDA (Personal Digital Assistant) IR device, among others. It is noted that in general, the device interface circuitry for the monitor, i.e., the video card, is separate from the USB controller because USB does not currently provide the necessary bandwidth for real time video signals.

FIG. 7F is a block diagram of an embodiment in which the PCI extender 120, the PCI bus 124B, and the various device interface circuits are comprised in the monitor 116, as described above with reference to FIGS. 3C, 4B, and 6B. Thus, as mentioned above, the other human interface devices may plug into the monitor 116, thereby coupling to the PCI bus 124B through respective device interface circuitry. As also noted above, in other embodiments the PCI extender 120, the PCI bus 124B, and device interface circuitry 126 may be included in other human interface devices as desired.

FIG. 7G is a block diagram of an embodiment in which the PCI extender 120 and the PCI bus 124B are included in the monitor 116, but the device interface circuitry for each human interface device is included in the respective device. Thus, as FIG. 7G shows, the keyboard 112 includes its interface circuitry 147, the mouse 114 includes its interface circuitry 148, and so on. In this embodiment, the monitor may provide one or more PCI ports through which the other human interface devices may couple to the PCI bus 124B. As noted above, in other embodiments the PCI extender 120 and the PCI bus 124B may be included in other human interface devices as desired.

Thus, in various embodiments, the one or more human interface devices may include one or more of a display monitor, where the human interface circuitry includes video display circuitry for providing video signals to the display monitor; a keyboard, where the human interface circuitry includes keyboard circuitry for communicating keyboard signals with the keyboard; a pointing device, where the human interface circuitry includes pointing device circuitry for communicating pointing device signals with the pointing device; a printer, where the human interface circuitry includes printer interface circuitry for communicating printer signals with the printer; a telephone, where the human interface circuitry includes telephone interface circuitry for communicating telephone signals with the telephone; a removable storage medium, such as an optical drive, a floppy drive, a tape drive, or a hard disc drive, where the human interface circuitry includes removable storage medium interface circuitry for communicating storage medium signals with the removable storage medium; a biometric sensor, where the biometric sensor is useable for access control, and where the human interface circuitry includes biometric sensor interface circuitry for communicating biometric sensor signals with the biometric sensor; a barcode reader, where the human interface circuitry includes barcode reader interface circuitry for communicating barcode signals with the barcode reader, a VR interface device, where the human interface circuitry includes VR interface device interface circuitry for communicating with the VR interface device, and a PDA IR device, where the human interface circuitry includes barcode reader interface circuitry for communicating IR signals with the PDA IR device, or any other type of removable storage medium.

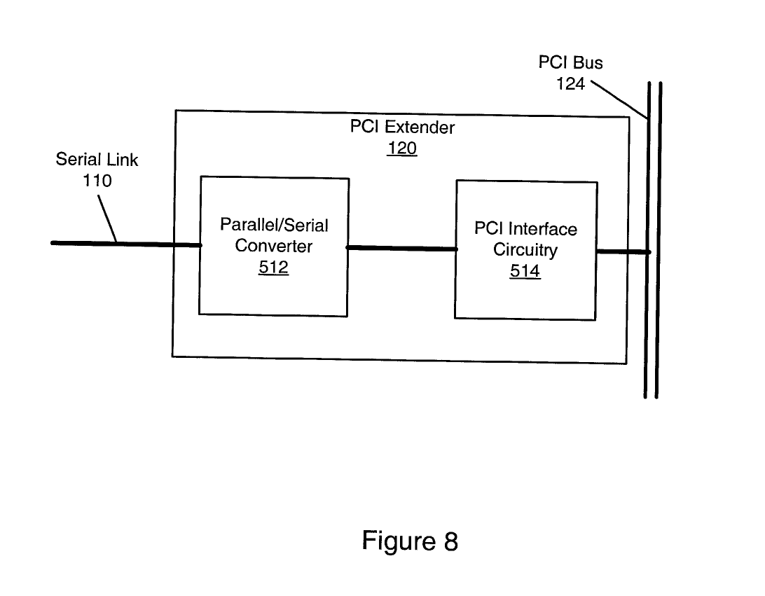

FIG. 8—Block Diagram of an Extender

FIG. 8 is a block diagram of an extender 120, according to one embodiment. As FIG. 8 shows, the extender 120 may couple to a transmission medium 110, such as a serial bus, as well as an I/O bus, such as a PCI bus 124. In one embodiment, the extender 120 may be a PCI extender, and may include a parallel/serial converter 512 which may couple to the serial bus 110, and which may be operable to convert between serial bus signals on the serial bus 110 and parallel signals. The extender 120 may also include bus interface circuitry, such as PCI interface circuitry 514 which may couple the parallel/serial converter 512 to the PCI bus 124, as shown. Thus, the extender 120 may operate to convert serial bus signals on the serial bus 110 to PCI signals on the PCI bus 124B, and vice versa. Said another way, each of the first extender and the second extender may include parallel/serial transceivers 512 for converting parallel data generated on the first I/O bus 124A and second I/O bus 124B, respectively, to serial data for transmission on the serial bus 110 and for converting serial data received from the serial bus 110 to parallel data for generation on the first I/O bus 124A and second I/O bus 124B, respectively.

Thus, referring to the computer systems described above where a computing system with a first I/O bus couples through a first extender to a second extender via a serial bus, and where the second extender couples through a second I/O bus to one or more human interface devices, the first extender 120A may include first I/O interface circuitry (parallel/serial converter 512) for interfacing to the first I/O bus 124A, and the second extender 120B may include second I/O interface circuitry (parallel/serial converter 512) for interfacing to the second I/O bus 124B. As mentioned above, it is noted that the transmission medium may comprise a serial bus coupled between the first extender and the second extender, where the serial bus may include first and second ends, and where the first end of the serial bus may be coupled to the first extender and the second end of the serial bus may be coupled to the second extender.

In this manner, the first extender 120A, the second extender 120B, and the transmission medium, e.g., the serial bus 110, may operate as a single I/O bus bridge between the first I/O bus 124A and the second I/O bus 124B, where the first extender 120A may operate as a first portion of the I/O bus bridge, and where the second extender 120B may operates as a second portion of the I/O bus bridge. In one embodiment, the first extender 120A and the second extender 120B may collectively implement an I/O bridge register set of the single I/O bus bridge. For example, in a preferred embodiment, the first extender 120A may implement a first half of the I/O bridge register set, and the second extender 120B may implement a second half of the I/O bridge register set. It is noted that in various other embodiments, the portion or fraction of the I/O bridge register set implemented by a particular extender 120 may range from none to all. In this embodiment, when the first extender 120A, the second extender 120B, and the transmission medium 110 operate as a single I/O bus bridge, the extension functionality operates in a manner transparent to human interface software drivers on the host, i.e., the computing system.

In one embodiment, the extension function may be provided by a first complete bridge, such as a PCI bridge, comprised in the computing system, and a second complete bridge located at the remote human interface. However, this embodiment may not provide the extension functionality in a manner transparent to human interface software drivers on the host, i.e., the computing system. In other words, the human interface device driver software may require special code to communicate over multiple bridges. Additionally, the use of multiple complete bridges may decrease performance of the system. For more details of this embodiment, please see U.S. Pat. No. 5,764,924 titled “Method and apparatus for extending a local PCI bus to a remote I/O backplane”, whose inventor is Soon Chul Hong, which was incorporated by reference above.

In one embodiment of the present invention, the first I/O bus and the second I/O I/O bus may be the same type of bus. For example, in one embodiment each of both the first I/O bus and the second I/O bus may be a Peripheral Component Interconnect (PCI) bus. In another embodiment, the first I/O bus may be a first type of bus, and the second I/O bus may be a second different type of bus. For example, in one embodiment, the first I/O bus may be a Peripheral Component Interconnect (PCI) bus, and the second I/O bus may not be a PCI bus. Alternatively, the second I/O bus may be a PCI bus, while the first I/O bus may not be a PCI bus.

Thus, in the case where the first I/O bus is a PCI bus and the second I/O bus is a PCI bus, the first extender, the second extender, and the transmission medium may collectively implement a PCI-PCI bridge. Furthermore, the first extender and the second extender may collectively implement a PCI-PCI bridge register set of the PCI-PCI bridge.

In one embodiment, the second I/O bus, the second I/O bus extender, and the human interface circuitry may form a human interface extender device. For example, the second I/O bus may be a PCI bus and the second I/O bus extender may be a PCI bus extender, in which case the human interface extender device may be operable to couple to one or more PCI human interface devices, where the human interface extender device and the one or more human interface devices are located at a user location. The human interface extender device may be further operable to couple to a remote computing system through a transmission medium, such as a high speed serial bus, thereby providing a means for a user to interface with a remote computing system. In one embodiment, the human interface extender device may be included in a chassis, thereby providing a convenient encapsulation of the human interface extension functionality.

For example, in one embodiment, the human interface device may be operable to receive user input from one or more human interface devices located in a first location, generate parallel bus signals on a parallel bus in response to the user input, generate serial bus signals on a serial bus in response to the parallel bus signals, and transmit the serial bus signals to a computing system, where the computing system is located in a second location located remotely from the first location.

For another example, the human interface extender device may be operable to receive serial signals from the computing system on a serial bus, generate parallel bus signals on a parallel bus in response to the received transmission signals, generate human interface signals in response to the parallel bus signals, and provide the human interface signals to one or more human interface devices. The one or more human interface devices may then operate in response to the human interface signals. Note that preferably the one or more human interface devices are located at a first location (along with the human interface extender device), and the computing system is located at a second location remotely located from the first location.

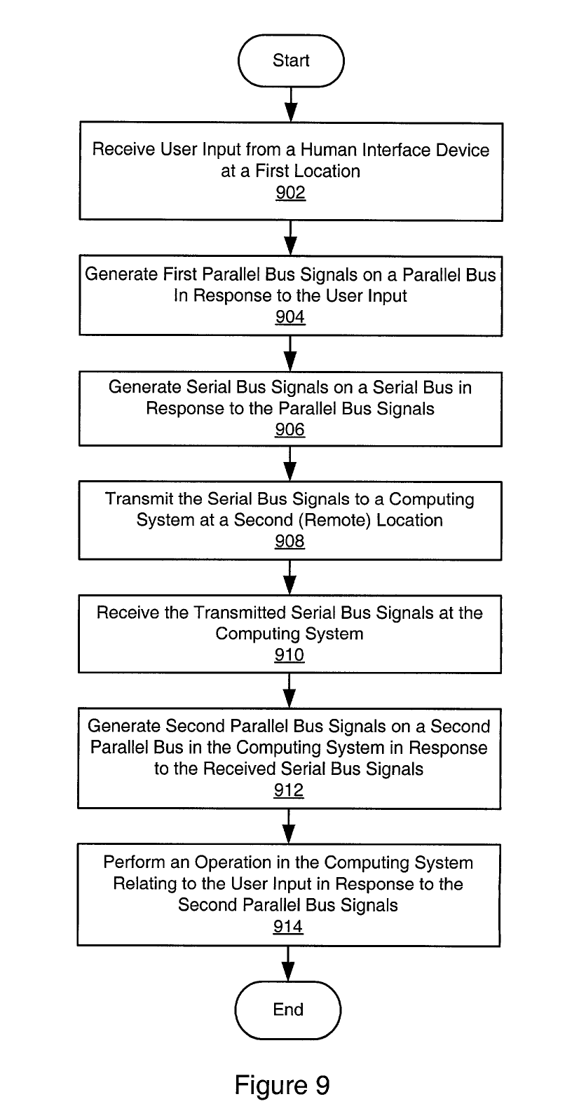

FIG. 9—Flowchart of a Method for Operating a Computer System

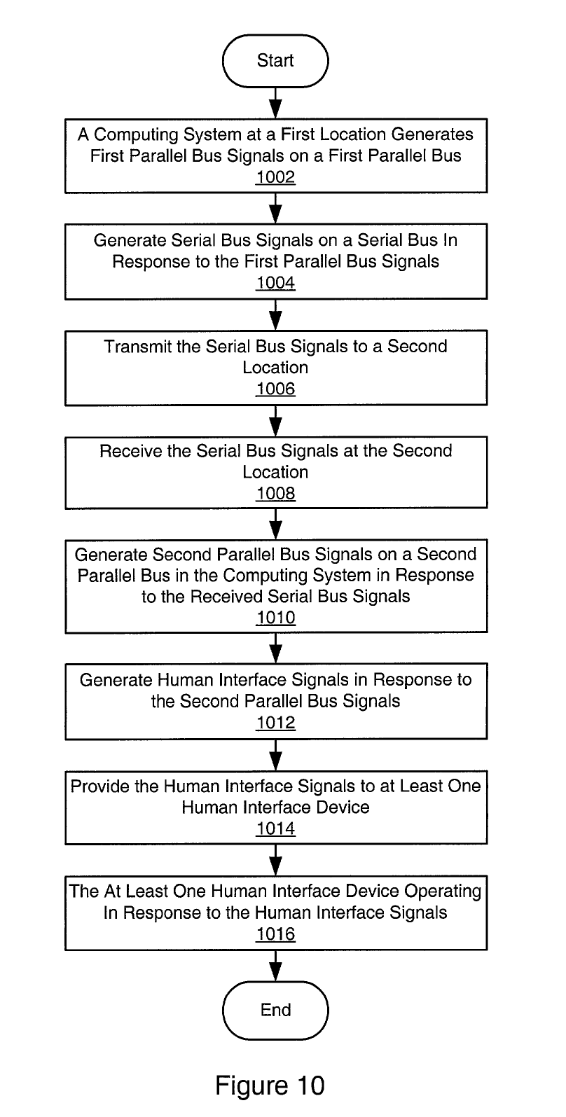

FIG. 9 flowcharts one embodiment of a method for operating a computer system, such as the computer systems described above, where the computer system comprises a computing system and one or more human interface devices, where the one or more human interface devices are located remotely from the computing system. For example, in one embodiment, the one or more human interface devices may be located more than 10 feet from the computing system. In another embodiment, the one or more human interface devices may be located more than 20 feet from the computing system. It should be noted that in various embodiments one or more of the following steps may be performed in a different order than shown, or may be omitted entirely. Other additional steps may also be performed as desired. The method presented below with reference to FIG. 9 describes communication flow from a human interface device at a remote human interface to a computing system. FIG. 10, described subsequently, flowcharts communication flow from the computing system to the human interface device. In other words, the two methods describe complementary data flows through a common system.

As FIG. 9 shows, in 902 user input may be received from a human interface device located in a first location. As mentioned above, the human interface device may be one of a monitor, a keyboard, a mouse, audio speakers (or headphones), a microphone, a printer, a scanner, a telephone, a removable storage medium (e.g., an optical drive, a floppy drive, a tape drive, or a hard disc drive), a biometric sensor (e.g., for access control), a barcode reader, a VR interface device, and a PDA IR device, among others. It is noted that in one embodiment, each of the human interface devices may have corresponding human interface circuitry, or device interface circuitry, as described above, for communicating human interface device signals with the human interface device. For example, where the one or more human interface devices comprise a display monitor, the human interface circuitry may include video display circuitry for providing video signals to the display monitor. Where the one or more human interface devices comprise a keyboard, the human interface circuitry may include keyboard circuitry for communicating keyboard signals with the keyboard. Thus, in one embodiment, the user input from the human interface device may be received by the device interface circuitry.

In 904, first I/O bus signals may be generated on a first I/O bus in response to the user input. In one embodiment the first I/O bus signals may be generated on a first I/O bus by the device interface circuitry corresponding to the human interface device. In one embodiment, the first I/O bus signals generated on the first I/O bus may comprise parallel bus signals generated on a parallel bus, such as a PCI bus.

In 906, transmission signals may be generated on a transmission medium in response to the first I/O bus signals, then in 908, the transmission signals may be transmitted to a computing system located at a second location which is located remotely from the first location. In one embodiment, the computer system may comprise a first extender, located in the first location, and the generation of the transmission signals and the transmittal of the transmission signals to the computing system may be performed by the first extender.

Additionally, in one embodiment, the transmission medium coupling the first and second extenders may be a 4-wire cable. In another embodiment, the transmission medium may be a serial bus coupled between the first extender and the second extender, where the serial bus includes first and second ends, and where the first end of the serial bus is coupled to the first extender and the second end of the serial bus is coupled to the second extender. Thus, the transmission signals may be serial bus signals. In one embodiment, the transmission signals generated on the transmission medium may be high speed serial bus signals generated on a high speed serial bus. As mentioned above, although the transmission medium is preferably a serial bus, in some embodiments, the transmission medium may be a parallel bus. As also mentioned above, in various other embodiments, the transmission medium may be a wireless medium, an IEEE 1394 or IEEE 1394.2 bus, a fiber optic medium, a switched fabric bus, such as an Infiniband bus, or any other suitable transmission medium.

In 910, the computing system may receive the transmission signals from the transmission medium. Then, as indicated in 912, second I/O bus signals may be generated on a second I/O bus in the computing system in response to the received transmission signals. In one embodiment, the computing system may comprise a second extender, and the reception of the transmission signals from the transmission medium, and the generation of the second I/O bus signals on the second I/O bus may be performed by the second extender.

Finally, in 914, the computing system may perform an operation in response to the second I/O bus signals, where the operation is in response to the user input.

As mentioned above, in one embodiment, the first extender may include first I/O interface circuitry for interfacing to the first I/O bus, and the second extender may include second I/O interface circuitry for interfacing to the second I/O bus. In one embodiment, the first extender, the second extender, and the transmission medium may operate as a single I/O bus bridge between the first I/O bus and the second I/O bus. In one embodiment, the first extender may operate as a first portion of the I/O bus bridge, and the second extender may operate as a second portion of the I/O bus bridge. Furthermore, in one embodiment, the first extender and the second extender may collectively implement an I/O bridge register set of the single I/O bus bridge. For example, the first extender may implement a first fraction (e.g., a first half) of the I/O bridge register set, and the second extender may implement a second fraction (e.g., a second half) of the I.O. bridge register set.

Thus, in one embodiment, the CPU in the computing system may be operable to generate cycles on the first I/O bus to communicate with the one or more human interface devices coupled to the second I/O bus. In other words, the memory of the computer system may store software developed to communicate with a first human interface device that would be coupled to the first I/O bus of the computing system, and which may be executable to communicate with human interface devices coupled to either the first I/O bus or the second I/O bus.

As mentioned above, in one embodiment, the extenders may be operable to convert signals to and from transmission signals of the serial bus. For example, the first extender may be operable to receive first cycles on the first I/O bus and generate first serial data on the serial bus in response thereto. The second extender may be operable to receive the first serial data from the serial bus and generate second cycles on the second I/O bus. The second extender may be operable to receive third cycles on the second I/O bus and generate second serial data on the serial bus in response thereto, and the first extender may be operable to receive the second serial data from the serial bus and generate fourth cycles on the first I/O bus. Said another way, in one embodiment, each of the first extender and the second extender may include parallel/serial transceivers for converting parallel data generated on the first parallel bus and second parallel bus, respectively, to serial data for transmission on the serial bus and for converting serial data received from the serial bus to parallel data for generation on the first parallel bus and second parallel bus, respectively.

To summarize one embodiment of the above method, user input may be received from a human interface device located in a first location. First parallel bus signals may be generated on a first parallel bus in response to the user input. Serial bus signals may then be generated on a serial bus in response to the first parallel bus signals. The serial bus signals may then be transmitted to a computing system located in a second location which is located remotely from the first location. The computing system may receive the serial bus signals from the serial bus. Second parallel bus signals may then be generated on a second parallel bus in the computing system in response to the received serial bus signals. Finally, the computing system may perform an operation in response to the second parallel bus signals, where the operation is in response to the user input.

FIG. 10—Flowchart of another Method for Operating a Computer System

FIG. 10 flowcharts one embodiment of a method for operating a computer system, such as the computer systems described above, where the computer system comprises a computing system and one or more human interface devices located remotely from the computing system. It should be noted that in various embodiments one or more of the following steps may be performed in a different order than shown, or may be omitted entirely. Other additional steps may also be performed as desired.

As FIG. 10 shows, in 1002, a computing system may generate first I/O bus signals on a first I/O bus, where the first I/O bus signals comprise data for communicating with a human interface device, where the computing system is located at a first location.

In 1004, transmission signals may be generated on a transmission medium in response to the first I/O bus signals, and, as indicated in 1006, the transmission signals may be transmitted to a second location located remotely from the first location. In one embodiment, the computer system may include a first extender, located in the first location, which may generate the transmission signals on the transmission medium in response to the first I/O bus signals, and transmit the transmission signals to the second location.

In 1008, the transmission signals may be received at the second location, and as indicated in 1010, second I/O bus signals may be generated on a second I/O bus in response to the received transmission signals. In one embodiment, the computer system may include a second extender which may receive the transmission signals from the transmission medium, and generate the second I/O bus signals on a second I/O bus.

In 1012, human interface signals may be generated in response to the second I/O bus signals. Then, in 1014, the human interface signals may be provided to at least one human interface device.

Finally, the at least one human interface device may operate in response to the human interface signals. As mentioned above, in various embodiments, the one or more human interface devices may include any of a variety of human interface devices, as described above.

To summarize one embodiment of the above method, a computing system may generate first parallel bus signals on a first parallel bus, comprising data for communicating with a human interface device, where the computing system is located at a first location. Serial bus signals may be generated on a serial bus in response the first parallel bus signals. The serial bus signals may be transmitted to a second location located remotely from the first location. The serial bus signals may then be received at the second location, and second parallel bus signals may be generated on a second parallel bus in response to the received serial bus signals. Human interface signals may then be generated in response to the second parallel bus signals. The human interface signals may then be provided to at least one human interface device. Finally, the at least one human interface device may operate in response to the human interface signals.

Thus, by implementing the two methods described above with reference to FIGS. 9 and 10, respectively, communications may be facilitated between a computing system and a remote human interface. According to one embodiment of the invention, the combined methods may be implemented in the following manner:

In one embodiment, the computing system 102 may be operable to generate first I/O bus signals onto the first I/O bus 124A for communication with the one or more human interface devices. The first extender 120A may be operable to receive and convert the first I/O bus signals generated on the first I/O bus by the computing system 102 into first transmission signals suitable for transmission to the second extender 120B. The second extender 120B may be operable to receive and convert the first transmission signals received from the first extender 120A into second I/O bus signals on the second I/O bus 124B. The human interface circuitry 126 may be operable to receive the second I/O bus signals and generate human interface signals to the one or more human interface devices in response thereto.

The one or more human interface devices may be operable to generate human interface signals in response to user input, where the human interface signals are intended for the computing system. The human interface circuitry 126 may be operable to receive the human interface signals and generate third I/O bus signals on the second I/O bus. The second extender 120B may be operable to convert the third I/O bus signals on the second I/O bus 124B into second transmission signals suitable for transmission to the first extender 120A. The first extender 120A may be operable to receive the second transmission signals from the second extender 120B and convert the second transmission signals into fourth I/O bus signals on the first I/O bus 124A. The computing system may be operable to then receive the fourth I/O bus signals and perform operations based on the fourth I/O bus signals.

From a different perspective, the combined methods (described with reference to FIGS. 9 and 10) may be implemented in the following manner:

In one embodiment, the one or more human interface devices may be operable to generate human interface signals in response to user input, wherein the human interface signals are intended for the computing system. The human interface circuitry may be operable to receive the human interface signals and generate first I/O bus signals on the second I/O bus. The second extender may be operable to convert the first I/O bus signals on the second I/O bus into first transmission signals suitable for transmission to the first extender. The first extender may be operable to receive and convert the first transmission signals received from the second extender into second I/O bus signals on the first I/O bus. The computing system may be operable to receive the second I/O bus signals and perform operations based on the second I/O bus signals.

The computing system may be operable to generate third I/O bus signals onto the first I/O bus for communication with the one or more human interface devices. The first extender may be operable to receive and convert the third I/O bus signals generated on the first I/O bus by the computing system into second transmission signals suitable for transmission to the second extender. The second extender may be operable to receive and convert the second transmission signals received from the first extender into fourth I/O bus signals on the second I/O bus. The human interface circuitry may be operable to receive the fourth I/O bus signals and generate human interface signals to the one or more human interface devices in response thereto.

Thus, by implementing the above methods, the one or more human interface devices may operate as if they were located in the first location and directly connected by human interface cables to the computing system. In other words, the extended distance between the computing system and the remote human interface may be transparent to the user.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A system comprising a plurality of computer systems, the system comprising:
a plurality of computing systems each located at a first location, wherein each of the computing systems includes:
a CPU;
a memory medium coupled to the CPU;
a first I/O bus coupled to the CPU; and
a first extender coupled to the first I/O bus;
a plurality of human interface systems, wherein each respective one of the human interface systems corresponds to one of the plurality of computing systems, wherein each respective human interface system is located remotely from the first location, wherein each respective human interface system comprises:
a second extender;
a second I/O bus coupled to the second extender;
human interface circuitry coupled to the second I/O bus; and
one or more human interface devices coupled to the human interface circuitry; and
a plurality of transmission mediums, wherein each transmission medium corresponds to a respective computing system and its respective human interface system, wherein each transmission medium couples the first extender of the respective computing system to the respective second extender;
wherein each of the human interface systems is useable by a user to interface with its corresponding computing system.

2. The system of claim 1, wherein, for each of the plurality of computer systems,
the computing system is operable to generate first I/O bus signals onto the first I/O bus for communication with the one or more human interface devices;
wherein the first extender is operable to receive and convert the first I/O bus signals generated on the first I/O bus by said computing system into first transmission signals suitable for transmission to the second extender;
wherein the second extender is operable to receive and convert the first transmission signals received from the first extender into second I/O bus signals on the second I/O bus; and
wherein the human interface circuitry is operable to receive the second I/O bus signals and generate human interface signals to the one or more human interface devices in response thereto.

3. The system of claim 2,
wherein the one or more human interface devices are operable to generate human interface signals in response to user input, wherein the human interface signals are intended for the computing system;
wherein the human interface circuitry is operable to receive the human interface signals and generate third I/O bus signals on the second I/O bus;
wherein the second extender is operable to convert the third I/O bus signals on the second I/O bus into second transmission signals suitable for transmission to the first extender;
wherein the first extender is operable to receive the second transmission signals from the second extender and convert the second transmission signals into fourth I/O bus signals on the first I/O bus; and
wherein the computing system is operable to receive the fourth I/O bus signals and perform operations based on the fourth I/O bus signals.

4. The system of claim 1,
wherein the one or more human interface devices are operable to generate human interface signals in response to user input, wherein the human interface signals are intended for the respective computing system;
wherein the human interface circuitry is operable to receive the human interface signals and generate first I/O bus signals on the second I/O bus;
wherein the second extender is operable to convert the first I/O bus signals on the second I/O bus into first transmission signals suitable for transmission to the first extender;
wherein the first extender is operable to receive and convert the first transmission signals received from the second extender into second I/O bus signals on the first I/O bus; and
wherein the computing system is operable to receive the second I/O bus signals and perform operations based on the second I/O bus signals.

5. The system of claim 4,
wherein the computing system is operable to generate third I/O bus signals onto the first I/O bus for communication with the respective one or more human interface devices;
wherein the first extender is operable to receive and convert the third I/O bus signals generated on the first I/O bus by said computing system into second transmission signals suitable for transmission to the second extender;
wherein the second extender is operable to receive and convert the second transmission signals received from the first extender into fourth I/O bus signals on the second I/O bus; and
wherein the human interface circuitry is operable to receive the fourth I/O bus signals and generate human interface signals to the one or more human interface devices in response thereto.

6. The system of claim 1, wherein the one or more human interface devices comprise a display monitor; and
wherein the human interface circuitry includes video display circuitry for providing video signals to the display monitor.

7. The system of claim 1, wherein the one or more human interface devices comprise a keyboard; and
wherein the human interface circuitry includes keyboard circuitry for communicating keyboard signals with the keyboard.

8. The system of claim 1, wherein the one or more human interface devices comprise a pointing device; and
wherein the human interface circuitry includes pointing device circuitry for communicating pointing device signals with the pointing device.

9. The system of claim 1, wherein the one or more human interface devices comprise a printer; and
wherein the human interface circuitry includes printer interface circuitry for communicating printer signals with the printer.

10. The system of claim 1, wherein the one or more human interface devices comprise a telephone; and
wherein the human interface circuitry includes telephone interface circuitry for communicating telephone signals with the telephone.

11. The computer system of claim 1, wherein the one or more human interface devices comprise a removable storage medium; and
wherein the human interface circuitry includes removable storage medium interface circuitry for communicating storage medium signals with the removable storage medium.

12. The computer system of claim 11, wherein the removable storage medium comprises one of an optical drive, a floppy drive, a tape drive, and a hard disc drive.

13. The computer system of claim 11, wherein the one or more human interface devices comprise a biometric sensor, wherein the biometric sensor is useable for access control; and
wherein the human interface circuitry includes biometric sensor interface circuitry for communicating biometric sensor signals with the biometric sensor.

14. The computer system of claim 11, wherein the one or more human interface devices comprise a barcode reader; and
wherein the human interface circuitry includes barcode reader interface circuitry for communicating barcode signals with the barcode reader.

15. The computer system of claim 11, wherein the one or more human interface devices comprise a VR (Virtual Reality) interface device; and
wherein the human interface circuitry includes VR interface device interface circuitry for communicating VR interface device signals with the VR interface device.

16. The system of claim 1, wherein the one or more human interface devices are located more than 10 feet from the computing system.

17. The system of claim 1, wherein the one or more human interface devices are located more than 20 feet from the computing system.

18. The system of claim 1,
wherein the first extender includes first I/O interface circuitry for interfacing to the first I/O bus; and
wherein the second extender includes second I/O interface circuitry for interfacing to the second I/O bus.

19. The system of claim 1,
wherein the first extender, the second extender, and the transmission medium operate as a single I/O bus bridge between the first I/O bus and the second I/O bus.

20. The system of claim 19,
wherein the first extender operates as a first portion of the I/O bus bridge, and wherein the second extender operates as a second portion of the I/O bus bridge.

21. The system of claim 19,
wherein the first extender and the second extender collectively implement an I/O bridge register set of the single I/O bus bridge.

22. The system of claim 1, wherein the CPU in the computing system is operable to generate cycles on the first I/O bus to communicate with the one or more human interface devices coupled to the second I/O bus.

23. The system of claim 1, wherein the memory of the computer system stores software, wherein the software was developed to communicate with a first human interface device that would be coupled to the first I/O bus of the computing system;
wherein the software is executable to communicate with human interface devices coupled to either the first I/O bus or the second I/O bus.

24. The system of claim 1, wherein the one or more human interface devices operate as if they were located in the first location and directly connected by human interface cables to the computing system.

25. The system of claim 1, wherein the transmission medium coupling said first and second extenders is a 4-wire cable.

26. The system of claim 1,
wherein the transmission medium comprises a serial bus coupled between the first extender and the second extender, wherein the serial bus includes first and second ends, wherein the first end of the serial bus is coupled to the first extender and the second end of the serial bus is coupled to the second extender.

27. The system of claim 26, wherein the first extender is operable to receive first cycles on the first I/O bus and generate first serial data on the serial bus in response thereto;
wherein the second extender is operable to receive the first serial data from the serial bus and generate second cycles on the second I/O bus;
wherein the second extender is operable to receive third cycles on the second I/O bus and generate second serial data on the serial bus in response thereto; and
wherein the first extender is operable to receive the second serial data from the serial bus and generate fourth cycles on the first I/O bus.

28. The system of claim 1, wherein each of the first extender and the second extender includes parallel/serial transceivers for converting parallel data generated on the first I/O bus and second I/O bus, respectively, to serial data for transmission on the serial bus and for converting serial data received from the serial bus to parallel data for generation on the first I/O bus and second I/O bus, respectively.

29. The system of claim 1, wherein the transmission medium comprises a switched fabric bus coupled between the first extender and the second extender.

30. The system of claim 1, wherein the transmission medium comprises an Infiniband bus coupled between the first extender and the second extender.

31. The system of claim 1, wherein the transmission medium is an IEEE 1394 or IEEE 1394.2 bus.

32. The system of claim 1,
wherein the first I/O bus and the second I/O bus are the same type of bus.

33. The system of claim 1,
wherein the first I/O bus is a first type of bus; and
wherein the second I/O bus is a second different type of bus.

34. The system of claim 1,
wherein the first I/O bus is a Peripheral Component Interconnect (PCI) bus.

35. The system of claim 1,
wherein the second I/O bus is a Peripheral Component Interconnect (PCI) bus.

36. The system of claim 1,
wherein the first I/O bus is a Peripheral Component Interconnect (PCI) bus, and wherein the second I/O bus is a PCI bus;
wherein the first extender, the second extender, and the transmission medium collectively implement a PCI-PCI bridge; and
wherein the first extender and the second extender collectively implement a PCI-PCI bridge register set of the PCI-PCI bridge.

37. The system of claim 1, wherein each computing system further comprises:
a chassis; and
a power supply;
wherein the CPU, the memory medium, and the power supply are comprised in the chassis.

38. The system of claim 1, wherein each computing system further comprises:
a circuit card; and
a power supply;
wherein the CPU, the memory medium, and the power supply are comprised on the circuit card.

39. The system of claim 38, wherein the first extender and the first I/O bus are comprised on the circuit card.

40. The system of claim 1, wherein the second extender, the second I/O bus, and the human interface circuitry are comprised in a first human interface device of the one or more human interface devices.

41. The system of claim 40, wherein the first human interface device is one of a computer display monitor, a keyboard, a pointing device, a printer, a telephone, a removable storage medium, a biometric sensor, barcode reader, and a VR interface device.

42. A method for operating a plurality of computer systems, wherein each of the respective computer systems comprises a computing system and one or more human interface devices, wherein the computing systems of each of the computer systems are commonly located at a first location, wherein the one or more human interface devices for each of the computer systems are located at respective remote locations relative to the first location, wherein, for each of the plurality of computer systems, the method comprises:
receiving user input from a human interface device, wherein the human interface device is located in a second location remote from the first location;
generating first I/O bus signals on a first I/O bus in response to the user input;
generating transmission signals on a transmission medium in response to the first I/O bus signals;
transmitting the transmission signals to a computing system, wherein the computing system is located in the first location, wherein the first location is located remotely from the second location;
the computing system receiving the transmission signals from the transmission medium;
generating second I/O bus signals on a second I/O bus in the computing system in response to the received transmission signals; and
the computing system performing an operation in response to the second I/O bus signals, wherein the operation is in response to the user input.

43. The method of claim 42,
wherein the computer system comprises a first extender, wherein said first extender is located in said second location; and
wherein said generating transmission signals on a transmission medium in response to the first I/O bus signals, and said transmitting the transmission signals to a computing system are performed by said first extender.

44. The method of claim 42,
wherein the computing system comprises a second extender, wherein said receiving the transmission signals from the transmission medium, and said generating second I/O bus signals on a second I/O bus are performed by the second extender.

45. The method of claim 44, wherein the first extender, the first I/O bus, and the human interface circuitry are comprised in a first human interface device of the one or more human interface devices.

46. The method of claim 45, wherein the first human interface device is one of a computer display monitor, a keyboard, a pointing device, a printer, a telephone, a removable storage medium, a biometric sensor, barcode reader, and a VR interface device.

47. The method of claim 42, wherein one or both of the first and second I/O buses comprise parallel buses.

48. The method of claim 42, wherein one or both of the first and second I/O buses comprise PCI buses.

49. The method of claim 42, wherein the transmission medium comprises a serial bus.

50. A method for operating a plurality of computer systems, wherein each of the respective computer systems comprises a computing system and one or more human interface devices, wherein the computing systems of each of the computer systems are commonly located at a first location, wherein the one or more human interface devices for each of the computer systems are located at respective remote locations relative to the first location, wherein, for each of the plurality of computer systems, the method comprises:
a computing system generating first I/O bus signals on a first I/O bus, wherein the first I/O bus signals comprise data for communicating with a human interface device, wherein the computing system is located at the first location;
generating transmission signals on a transmission medium in response the first I/O bus signals;
transmitting the transmission signals to a second location, wherein the second location is located remotely from the first location;
receiving the transmission signals at the second location;
generating second I/O bus signals on a second I/O bus in response to the received transmission signals;
generating human interface signals in response to the second I/O bus signals;
providing the human interface signals to at least one human interface device; and
the at least one human interface device operating in response to the human interface signals.

51. The method of claim 50,
wherein the computing system comprises a first extender, wherein said first extender is located in said first location; and
wherein said generating transmission signals on a transmission medium in response to the first I/O bus signals, and said transmitting the transmission signals to a computing system are performed by said first extender.

52. The method of claim 50,
wherein the computer system comprises a second extender located at the second location, wherein said receiving the transmission signals from the transmission medium, and said generating second I/O bus signals on a second I/O bus are performed by the second extender.

53. The method of claim 52, wherein the second extender, the second I/O bus, and the human interface circuitry are comprised in a first human interface device of the one or more human interface devices.

54. The method of claim 53, wherein the first human interface device is one of a computer display monitor, a keyboard, a pointing device, a printer, a telephone, a removable storage medium, a biometric sensor, barcode reader, and a VR interface device.

55. The method of claim 50, wherein one or both of the first and second I/O buses comprise parallel buses.

56. The method of claim 50, wherein one or both of the first and second I/O buses comprise PCI buses.

57. The method of claim 50, wherein the transmission medium comprises a serial bus.

58. A system comprising a plurality of computer systems, the system comprising:
a plurality of computing systems each located at a first location, wherein each of the computing systems includes:
a CPU;
a memory medium coupled to the CPU;
a first parallel bus coupled to the CPU; and
a first extender coupled to the first parallel bus;
a plurality of human interface systems, wherein each respective one of the human interface systems corresponds to one of the plurality of computing systems, wherein each respective human interface system is located remotely from the first location, wherein each respective human interface system comprises:
a second extender;
a second parallel bus coupled to the second extender;
human interface circuitry coupled to the second parallel bus; and
one or more human interface devices coupled to the human interface circuitry; and
a plurality of serial buses, wherein each serial bus corresponds to a respective computing system and its respective human interface system, wherein each serial bus couples the first extender of the respective computing system to the respective second extender;
wherein each of the human interface systems is useable by a user to interface with its corresponding computing system.
